(19) United States
(12) Patent Application Publication
(10) Pub. No.: US 2024/0396982 A1
(43) Pub. Date: Nov. 28, 2024

(54) TRANSMISSION CONTROL PROTOCOL KEEP ALIVE PACKET OFFLOADING

(71) Applicant: QUALCOMM Incorporated, San Diego, CA (US)

(72) Inventors: Juan ZHANG, San Diego, CA (US); Ajith Tom PAYYAPPILLY, San Diego, CA (US); Sitaramanjaneyulu KANAMARLAPUDI, San Diego, CA (US); Uppinder BABBAR, San Diego, CA (US); Alok MITRA, San Diego, CA (US); Vamsi DOKKU, San Diego, CA (US); Huichun LIU, San Diego, CA (US); Suli ZHAO, San Diego, CA (US); Feilu LIU, San Diego, CA (US); Can ZHAO, San Diego, CA (US); Mahbod GHELICHI, San Diego, CA (US); Reza SHAHIDI, La Jolla, CA (US); Jie MAO, Beijing (CN)

(21) Appl. No.: 18/695,199

(22) PCT Filed: Nov. 10, 2021
(86) PCT No.: PCT/CN2021/129700

§ 371 Date: Mar. 25, 2024

(51) Int. Cl. H04L 69/16; H04L 69/28; H04W 52/02

(52) U.S. Cl. CPC H04L 69/16; H04L 69/28; H04W 52/0216

(57) ABSTRACT

Various aspects of the present disclosure generally relate to wireless communication. In some aspects, a modem may receive, from an applications processor of a user equipment (UE), a registration message associated with keep alive offloading. Accordingly, the modem may filter incoming transmission control protocol (TCP) packets to determine a current sequence number and a current acknowledgement number. The modem may further receive, from the applications processor, an indication to perform a keep alive procedure. Accordingly, the modem may transmit, periodically. TCP keep alive packets based on the current sequence number and the current acknowledgement number. Numerous other aspects are described.

### FIELD OF THE DISCLOSURE

Aspects of the present disclosure generally relate to wireless communication and to techniques and apparatuses for offloading transmission control protocol keep alive packets.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a modem of a user equipment (UE). The method may include receiving, from an applications processor of the UE, a registration message associated with keep alive offloading. The method may further include filtering incoming transmission control protocol (TCP) packets to determine a current sequence number and a current acknowledgement number. The method may include receiving, from the applications processor, an indication to perform a keep alive procedure. The method may further include transmitting, periodically, TCP keep alive packets based on the current sequence number and the current acknowledgement number.

Some aspects described herein relate to an apparatus for wireless communication at a modem of a UE. The apparatus may include a memory and one or more processors coupled to the memory. The one or more processors may be configured to receive, from an applications processor of the UE, a registration message associated with keep alive offloading. The one or more processors may be further configured to filter incoming TCP packets to determine a current sequence number and a current acknowledgement number. The one or more processors may be configured to receive, from the applications processor, an indication to perform a keep alive procedure. The one or more processors may be further configured to transmit, periodically, TCP keep alive packets based on the current sequence number and the current acknowledgement number.

Some aspects described herein relate to a non-transitory computer-readable medium that stores a set of instructions for wireless communication by a modem of a UE. The set of instructions, when executed by one or more processors of the modem, may cause the modem to receive, from an applications processor of the UE, a registration message associated with keep alive offloading. The set of instructions, when executed by one or more processors of the modem, may further cause the modem to filter incoming TCP packets to determine a current sequence number and a current acknowledgement number. The set of instructions, when executed by one or more processors of the modem, may cause the modem to receive, from the applications processor, an indication to perform a keep alive procedure. The set of instructions, when executed by one or more processors of the modem, may further cause the modem to transmit, periodically, TCP keep alive packets based on the current sequence number and the current acknowledgement number.

Some aspects described herein relate to an apparatus for wireless communication. The apparatus may include means for receiving, from an applications processor, a registration message associated with keep alive offloading. The apparatus may further include means for filtering incoming TCP packets to determine a current sequence number and a current acknowledgement number. The apparatus may include means for receiving, from the applications processor, an indication to perform a keep alive procedure. The apparatus may further include means for transmitting, periodically, TCP keep alive packets based on the current sequence number and the current acknowledgement number.

Some aspects described herein relate to a method of wireless communication performed by an applications processor of a UE. The method may include transmitting, to a modem of the UE, a registration message associated with keep alive offloading. The method may further include transmitting, to the modem, an indication to perform a TCP keep alive procedure. The method may include transmitting, to the modem, an indication to stop performing the keep alive procedure.

Some aspects described herein relate to an apparatus for wireless communication at an applications processor of a UE. The apparatus may include a memory and one or more processors coupled to the memory. The one or more processors may be configured to transmit, to a modem of the UE, a registration message associated with keep alive offloading. The one or more processors may be further configured to transmit, to the modem, an indication to perform a TCP keep alive procedure. The one or more processors may be configured to transmit, to the modem, an indication to stop performing the keep alive procedure.

Some aspects described herein relate to a non-transitory computer-readable medium that stores a set of instructions for wireless communication by an applications processor of a UE. The set of instructions, when executed by the applications processor, may cause the applications processor to transmit, to a modem of the UE, a registration message associated with keep alive offloading. The set of instructions, when executed by the applications processor, may further cause the applications processor to transmit, to the modem, an indication to perform a TCP keep alive procedure. The set of instructions, when executed by the applications processor, may cause the applications processor to transmit, to the modem, an indication to stop performing the keep alive procedure.

Some aspects described herein relate to an apparatus for wireless communication. The apparatus may include means for transmitting, to a modem, a registration message associated with keep alive offloading. The apparatus may further include means for transmitting, to the modem, an indication to perform a TCP keep alive procedure. The apparatus may include means for transmitting, to the modem, an indication to stop performing the keep alive procedure.

Some aspects described herein relate to a method of wireless communication performed by a UE. The method may include determining a plurality of TCP heartbeat intervals based on a minimum heartbeat interval, wherein each TCP heartbeat interval, of the plurality of TCP heartbeat intervals, is associated with a corresponding application. The method may further include transmitting, for each application, TCP keep alive packets according to a corresponding interval of the plurality of TCP heartbeat intervals.

Some aspects described herein relate to an apparatus for wireless communication at a UE. The apparatus may include a memory and one or more processors coupled to the memory. The one or more processors may be configured to determine a plurality of TCP heartbeat intervals based on a minimum heartbeat interval, wherein each TCP heartbeat interval, of the plurality of TCP heartbeat intervals, is associated with a corresponding application. The one or more processors may be further configured to transmit, for each application, TCP keep alive packets according to a corresponding interval of the plurality of TCP heartbeat intervals.

Some aspects described herein relate to a non-transitory computer-readable medium that stores a set of instructions for wireless communication by a UE. The set of instructions, when executed by one or more processors of the UE, may cause the UE to determine a plurality of TCP heartbeat intervals based on a minimum heartbeat interval, wherein each TCP heartbeat interval, of the plurality of TCP heartbeat intervals, is associated with a corresponding application. The set of instructions, when executed by one or more processors of the UE, may further cause the UE to transmit, for each application, TCP keep alive packets according to a corresponding interval of the plurality of TCP heartbeat intervals.

Some aspects described herein relate to an apparatus for wireless communication. The apparatus may include means for determining a plurality of TCP heartbeat intervals based on a minimum heartbeat interval, wherein each TCP heartbeat interval, of the plurality of TCP heartbeat intervals, is associated with a corresponding application. The apparatus may further include means for transmitting, for each application, TCP keep alive packets according to a corresponding interval of the plurality of TCP heartbeat intervals.

Some aspects described herein relate to a method of wireless communication performed by a UE. The method may include receiving a range associated with a period for TCP keep alive packets. The method may further include transmitting the TCP keep alive packets according to a first interval within the range. The method may include transmitting the TCP keep alive packets according to a second interval within the range based on an outcome associated with the TCP keep alive packets according to the first interval. The method may further include storing an updated range based at least in part on the first interval and the second interval.

Some aspects described herein relate to an apparatus for wireless communication at a UE. The apparatus may include a memory and one or more processors coupled to the memory. The one or more processors may be configured to receive a range associated with a period for TCP keep alive packets. The one or more processors may be further configured to transmit the TCP keep alive packets according to a first interval within the range. The one or more processors may be configured to transmit the TCP keep alive packets according to a second interval within the range based on an outcome associated with the TCP keep alive packets according to the first interval. The one or more processors may be further configured to store an updated range based at least in part on the first interval and the second interval.

Some aspects described herein relate to a non-transitory computer-readable medium that stores a set of instructions for wireless communication by a UE. The set of instructions, when executed by one or more processors of the UE, may cause the UE to receive a range associated with a period for TCP keep alive packets. The set of instructions, when executed by one or more processors of the UE, may further cause the UE to transmit the TCP keep alive packets according to a first interval within the range. The set of instructions, when executed by one or more processors of the UE, may cause the UE to transmit the TCP keep alive packets according to a second interval within the range based on an outcome associated with the TCP keep alive packets according to the first interval. The set of instructions, when executed by one or more processors of the UE, may further cause the UE to store an updated range based at least in part on the first interval and the second interval.

Some aspects described herein relate to an apparatus for wireless communication. The apparatus may include means for receiving a range associated with a period for TCP keep alive packets. The apparatus may further include means for transmitting the TCP keep alive packets according to a first interval within the range. The apparatus may include means for transmitting the TCP keep alive packets according to a second interval within the range based on an outcome associated with the TCP keep alive packets according to the first interval. The apparatus may further include means for storing an updated range based at least in part on the first interval and the second interval.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example associated with an architecture for offloading transmission control protocol (TCP) keep alive packets to a modem, in accordance with the present disclosure.

FIGS. 4A, 4B, 4C, and 4D are diagrams illustrating examples associated with offloading TCP keep alive packets to a modem, in accordance with the present disclosure.

FIGS. 5A and 5B are diagrams illustrating examples associated with offloading TCP keep alive packets to a modem, in accordance with the present disclosure.

FIG. 6 is a diagram illustrating an example associated with offloading TCP keep alive packets to a modem, in accordance with the present disclosure.

FIGS. 7 and 8 are diagrams illustrating examples associated with TCP heartbeat interval alignment, in accordance with the present disclosure.

FIG. 9 is a diagram illustrating an example associated with TCP heartbeat interval detection, in accordance with the present disclosure.

FIGS. 10 and 11 are diagrams illustrating example processes associated with offloading TCP keep alive packets to a modem, in accordance with the present disclosure.

FIG. 12 is a diagram illustrating an example process associated with TCP heartbeat interval alignment, in accordance with the present disclosure.

FIG. 13 is a diagram illustrating an example process associated with TCP heartbeat interval detection, in accordance with the present disclosure.

FIG. 14 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

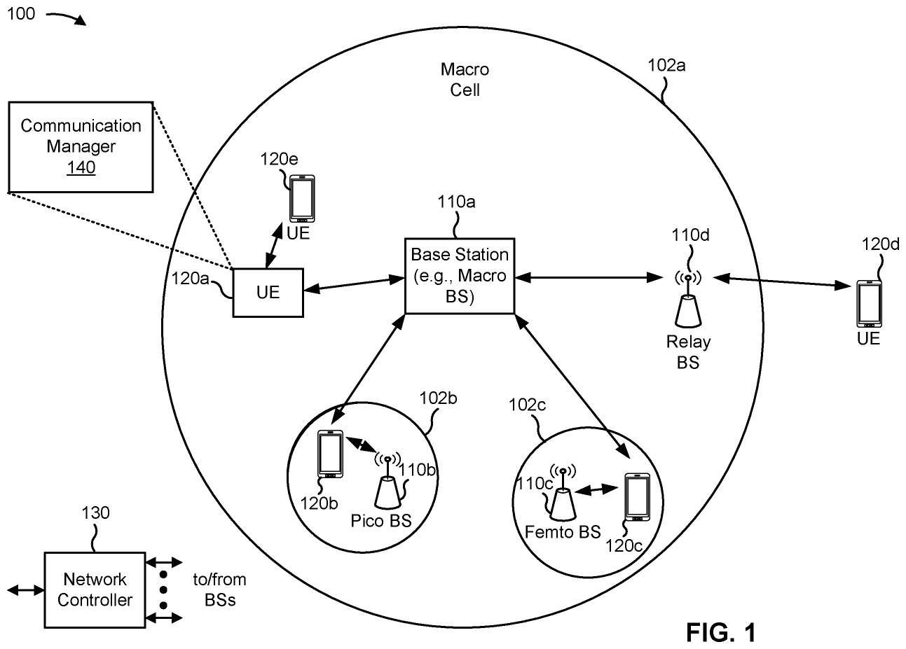

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a modem. As described in more detail elsewhere herein, the modem may receive (e.g., from an applications processor of the UE 120) a registration message associated with keep alive offloading; filter incoming transmission control protocol (TCP) packets to determine a current sequence number and a current acknowledgement number; receive (e.g., from the applications processor) an indication to perform a keep alive procedure; and transmit, periodically, TCP keep alive packets based on the current sequence number and the current acknowledgement number. Additionally, or alternatively, the modem may perform one or more other operations described herein.

In some aspects, the UE 120 may include an applications processor. As described in more detail elsewhere herein, the applications processor may transmit (e.g., to a modem of the UE 120) a registration message associated with keep alive offloading; transmit (e.g., to the modem) an indication to perform a TCP keep alive procedure; and transmit (e.g., to the modem) an indication to stop performing the keep alive procedure. Additionally, or alternatively, the applications processor may perform one or more other operations described herein.

In some aspects, the UE 120 may include a communication manager 140. As described in more detail elsewhere herein, the communication manager 140 may determine a plurality of TCP heartbeat intervals based on a minimum heartbeat interval, wherein each TCP heartbeat interval, of the plurality of TCP heartbeat intervals, is associated with a corresponding application, and transmit, for each application, TCP keep alive packets according to a corresponding interval of the plurality of TCP heartbeat intervals. Additionally, or alternatively, the communication manager 140 may receive a range associated with a period for TCP keep alive packets; transmit the TCP keep alive packets according to a first interval within the range; transmit the TCP keep alive packets according to a second interval within the range based on an outcome associated with the TCP keep alive packets according to the first interval; and store an updated range based at least in part on the first interval and the second interval. Additionally, or alternatively, the communication manager 140 may perform one or more other operations described herein.

As indicated above, FIG. 1 is provided as an example. Other examples may differ from what is described with regard to FIG. 1.

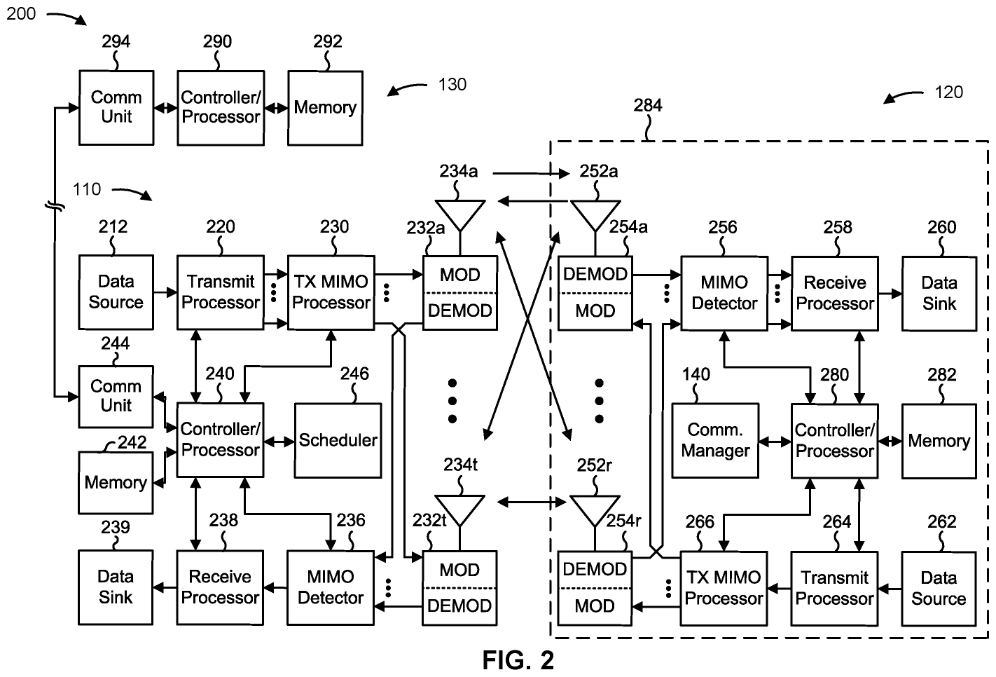

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

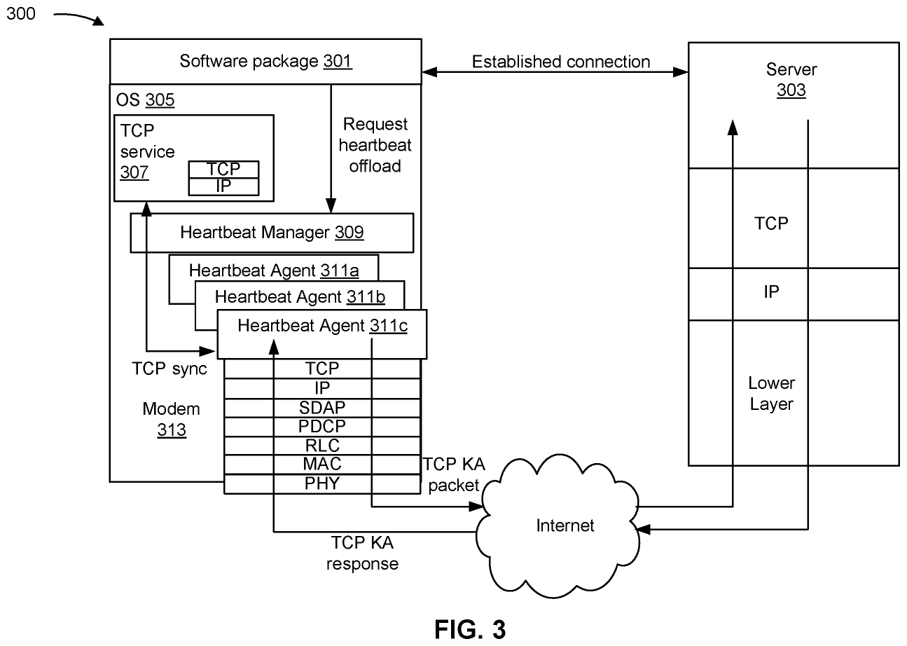

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-14).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-14).

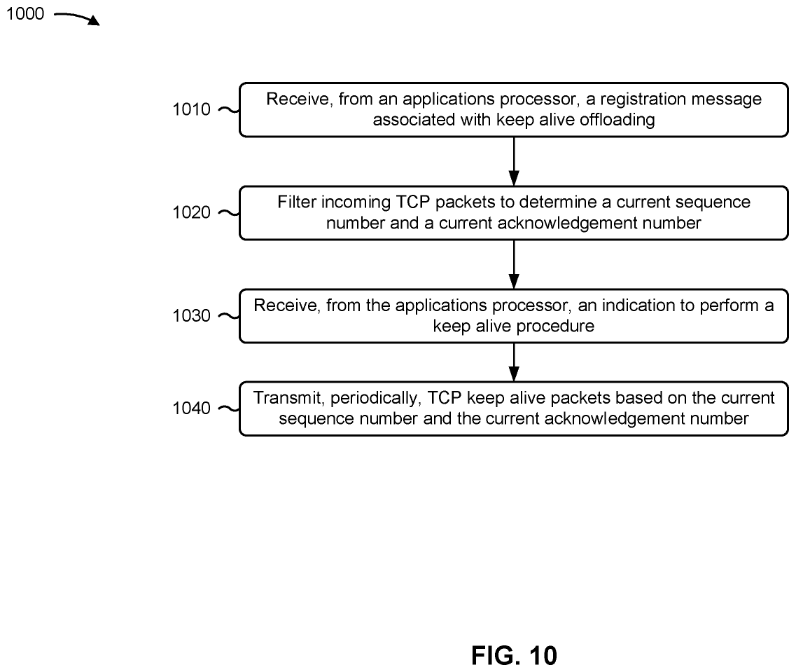

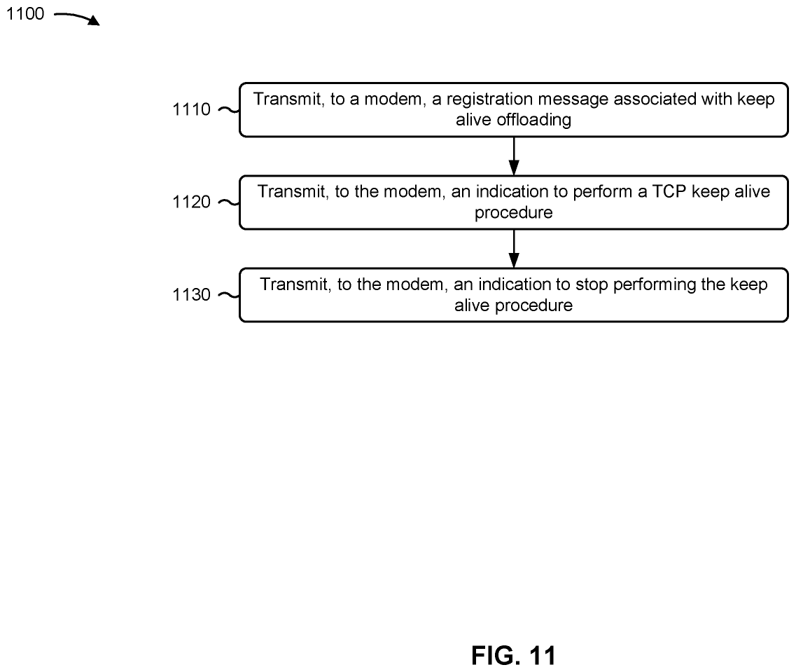

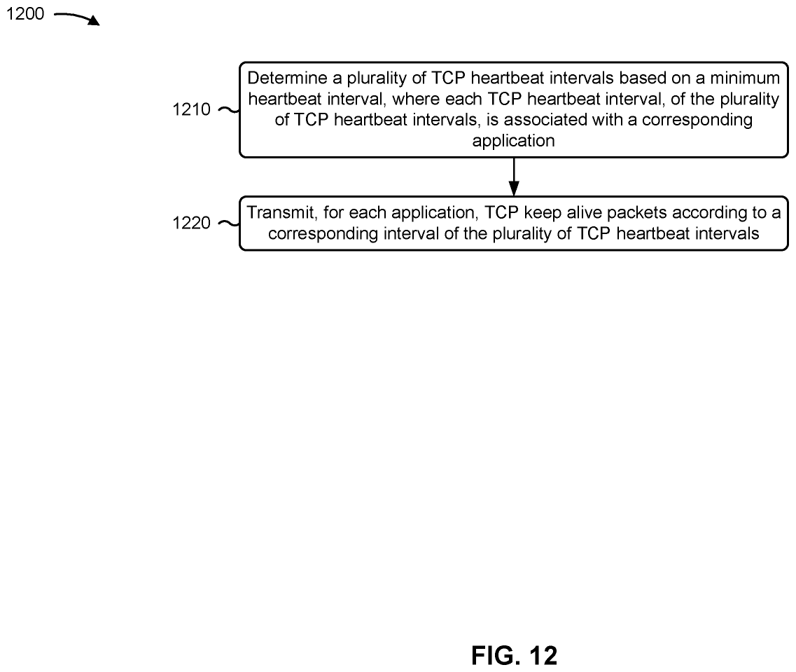

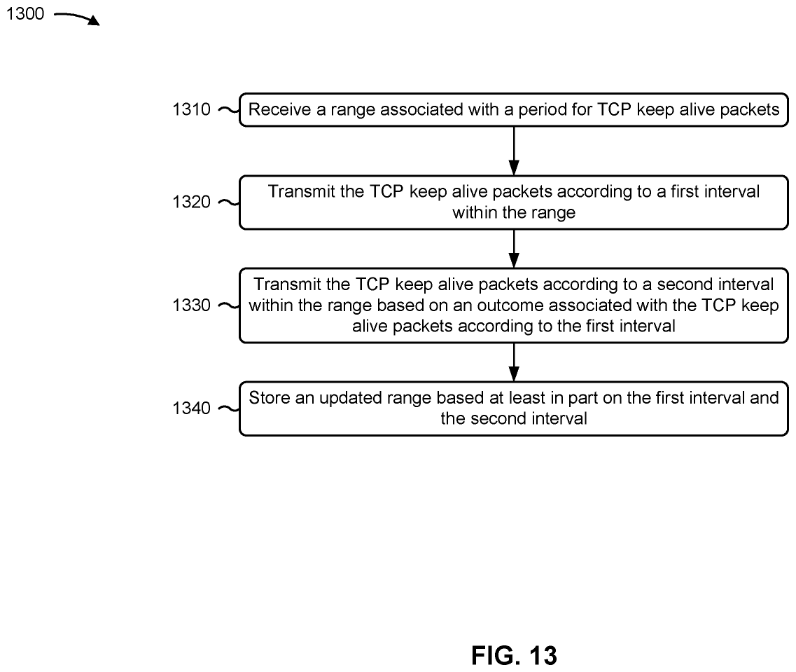

The controller/processor 240 of the base station 110, the controller/processor 280 of the UE 120, and/or any other component(s) of FIG. 2 may perform one or more techniques associated with offloading TCP keep alive packets, as described in more detail elsewhere herein. For example, the controller/processor 240 of the base station 110, the controller/processor 280 of the UE 120, and/or any other component(s) of FIG. 2 may perform or direct operations of, for example, process 1000 of FIG. 10, process 1100 of FIG. 11, process 1200 of FIG. 12, process 1300 of FIG. 13, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1000 of FIG. 10, process 1100 of FIG. 11, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, the UE 120 may include means for receiving, at a modem of the UE and from an applications processor of the UE, a registration message associated with keep alive offloading; means for filtering incoming TCP packets to determine a current sequence number and a current acknowledgement number; means for receiving, at the modem and from the applications processor, an indication to perform a keep alive procedure; and/or means for transmitting, periodically, TCP keep alive packets based on the current sequence number and the current acknowledgement number. In some aspects, the means for the UE to perform operations described herein may include, for example, one or more of antenna 252 or modem 254.

In some aspects, the UE 120 may include means for transmitting, from an applications processor of the UE and to a modem of the UE, a registration message associated with keep alive offloading; means for transmitting, from the applications processor and to the modem, an indication to perform a TCP keep alive procedure; and/or means for transmitting, from the applications processor and to the modem, an indication to stop performing the keep alive procedure. In some aspects, the means for the UE to perform operations described herein may include, for example, one or more of MIMO detector 256, receive processor 258, transmit processor 264, TX MIMO processor 266, controller/processor 280, or memory 282.

In some aspects, the UE 120 may include means for determining a plurality of TCP heartbeat intervals based on a minimum heartbeat interval, wherein each TCP heartbeat interval, of the plurality of TCP heartbeat intervals, is associated with a corresponding application; and/or means for transmitting, for each application, TCP keep alive packets according to a corresponding interval of the plurality of TCP heartbeat intervals. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

Additionally, or alternatively, the UE 120 may include means for receiving a range associated with a period for TCP keep alive packets; means for transmitting the TCP keep alive packets according to a first interval within the range; means for transmitting the TCP keep alive packets according to a second interval within the range based on an outcome associated with the TCP keep alive packets according to the first interval; and/or means for storing an updated range based at least in part on the first interval and the second interval. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

A UE may execute one or more applications that use transmission control protocol (TCP) to communicate with one or more remote servers. Accordingly, even when no data is being sent to, or received from, a remote server, a corresponding TCP connection with an application on the UE is maintained by the application transmitting TCP keep alive packets periodically. However, the applications processor consumes power and processing resources by periodically generating TCP keep alive packets for transmission to the remote server.

Some techniques and apparatuses described herein enable an applications processor of a UE (e.g., UE 120) to offload a TCP keep alive procedure to a modem of the UE 120. As a result, the applications processor conserves power and processing resources because the modem periodically generates and transmits TCP keep alive packets to the remote server.

FIG. 3 is a diagram illustrating an example 300 associated with an architecture for offloading TCP keep alive packets to a modem, in accordance with the present disclosure. As shown in FIG. 3, example 300 includes a software package 301 that has established a connection (e.g., a TCP connection) with a remote server 303. The software package 301 may include an Android Package (APK), an IOS App Store Package (IPA), and/or another software package. The software package 301 may be executed on a UE (e.g., UE 120) and is supported by an operating system (OS) 305. The OS 305 may include an Android OS, an iOS, and/or another operating system. The OS 305 may maintain a TCP service 307 with a TCP and Internet protocol (IP) stack associated with the software package 301. Accordingly, TCP packets sent by the software package 301 and received from the remote server 303 are handled by the TCP service 307.

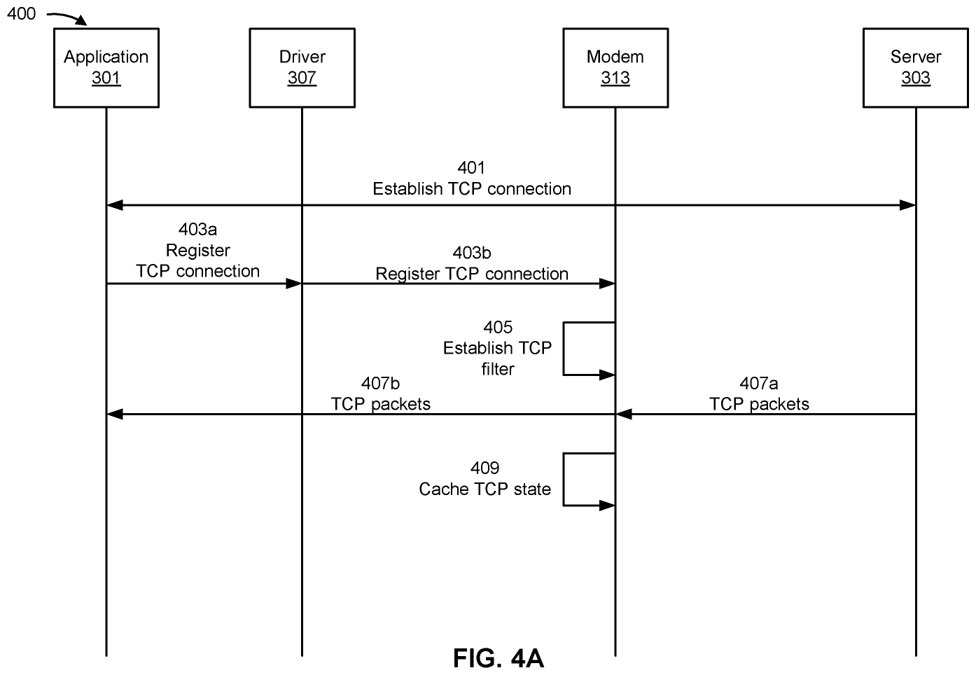

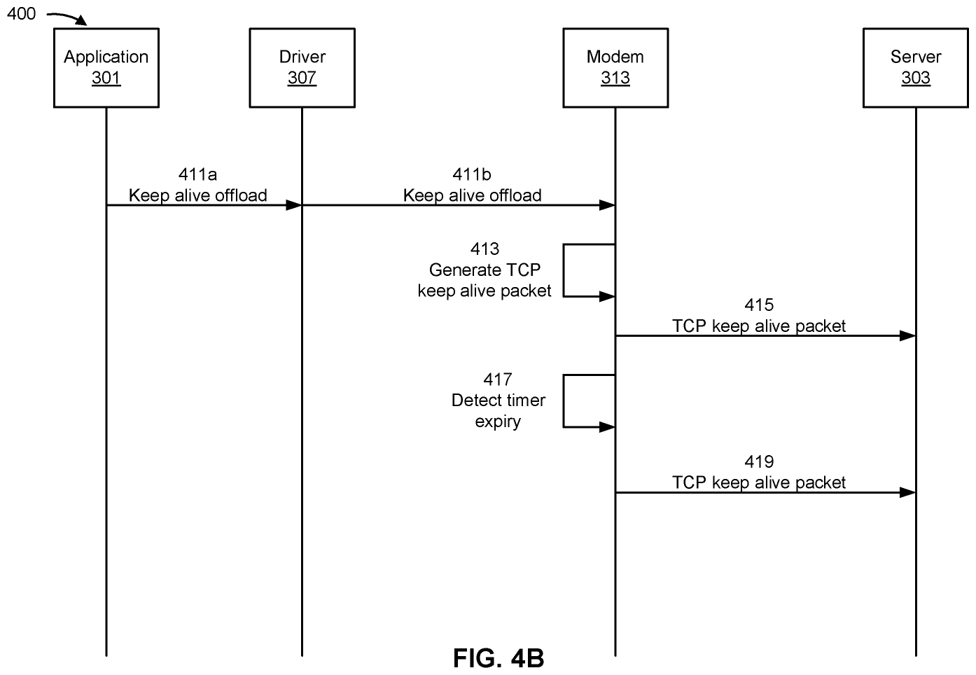

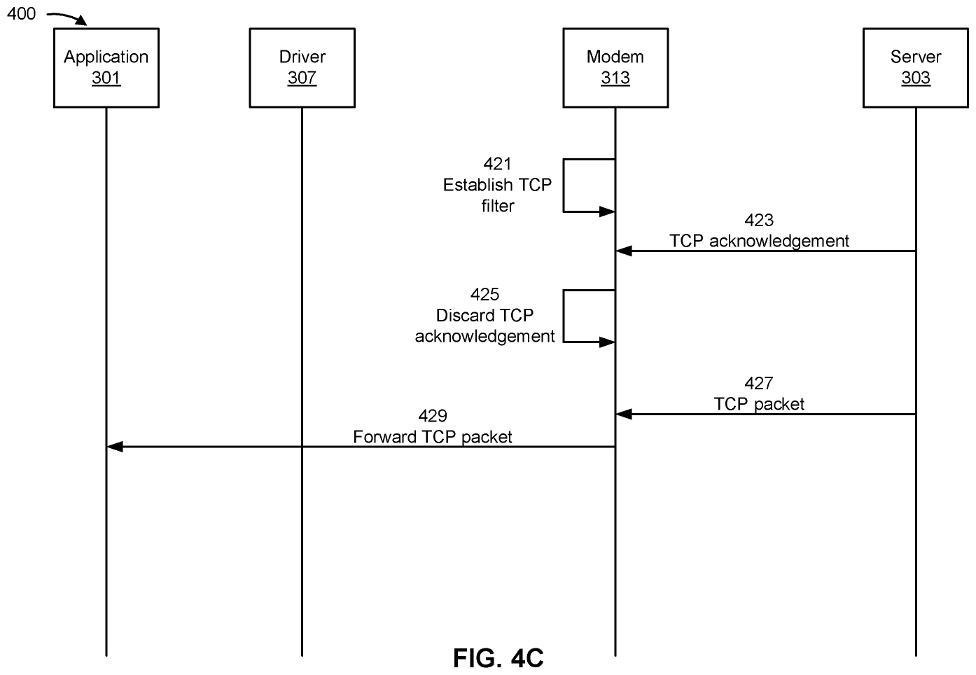

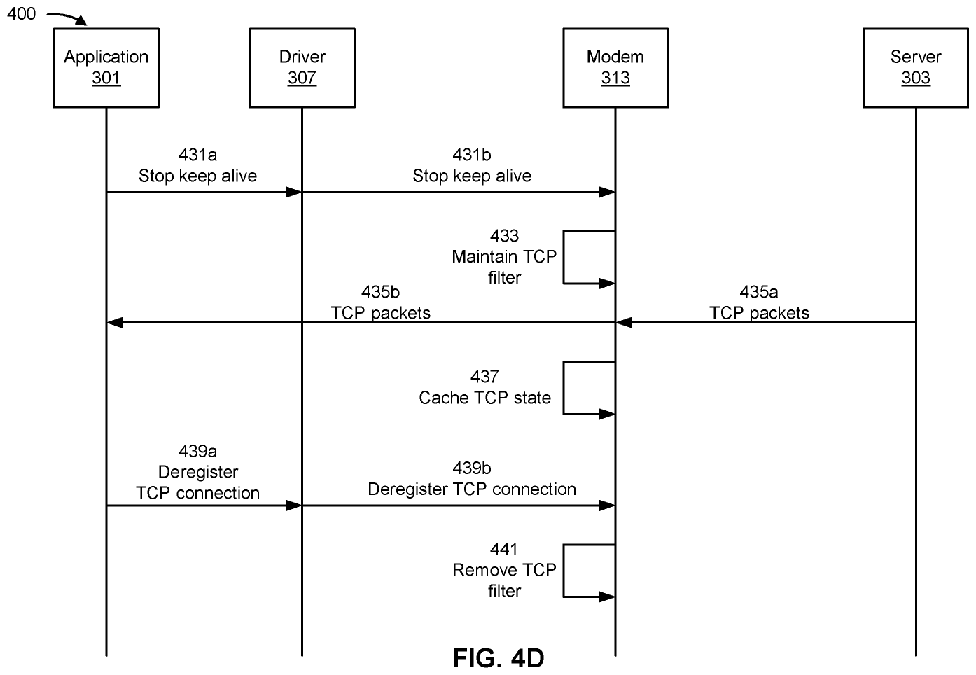

In some aspects, and as described in connection with FIGS. 4A-4D, FIGS. 5A-5B, and FIG. 6, the TCP service 307 may be implemented within a driver associated with a modem 313. The modem 313 may perform transmissions between a physical (PHY) layer of the UE 120 and a corresponding lower layer of the remote server 303. Additionally, the modem 313 may implement one or more additional layers, such as a medium access control (MAC) layer, a radio link control (RLC) layer, a packet data convergence protocol (PDCP) layer, and/or a service data adaption protocol (SDAP) layer, as shown in FIG. 3.

In some aspects, the modem 313 may further implement a TCP and IP stack to enable the modem 313 to perform a TCP keep alive procedure for the software package 301 (and/or other applications executed by the UE 120). For example, a heartbeat manager 309 implemented at the modem 313 may receive a request from the software package 301 (and/or other applications executed by the UE 120) associated with TCP keep alive offloading. Accordingly, the heartbeat manager may implement a corresponding heartbeat agent (e.g., agent 311a, agent 311b, and/or agent 311c, as shown in FIG. 3) for the application that requested TCP keep alive offloading.

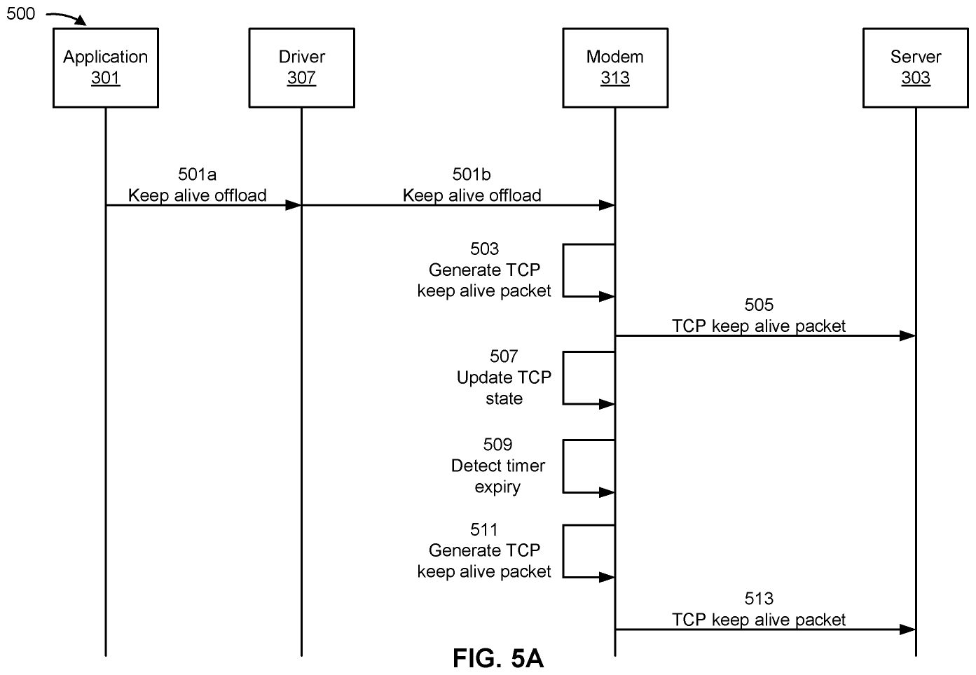

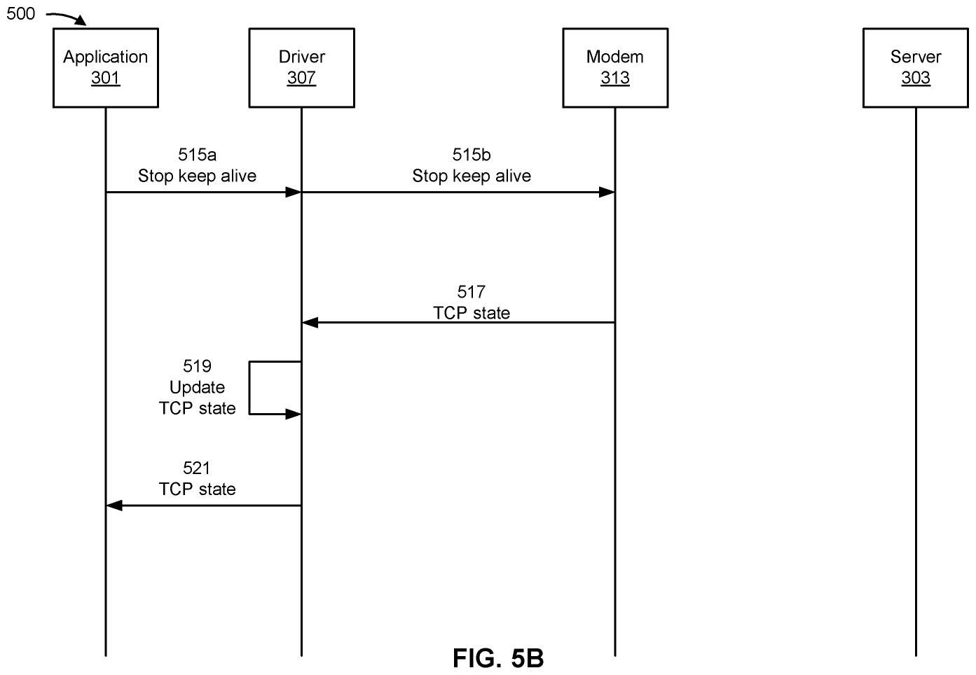

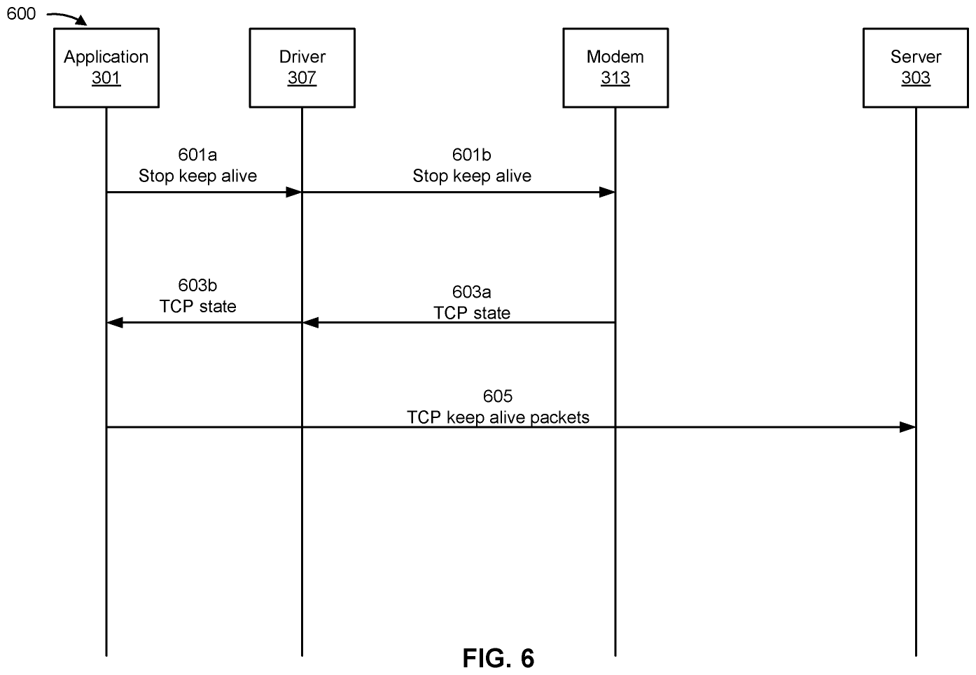

Accordingly, for each application, the corresponding heartbeat agent transmits TCP keep alive (KA) packets to the remote server 303 and receives acknowledgements associated with the TCP KA packets from the remote server 303 (e.g., as described in connection with FIGS. 4A-4D and/or FIGS. 5A-5B). When a TCP packet arrives from the remote server 303 that is not an acknowledgement associated with the TCP KA packets and/or when the software package 301 determines to stop TCP keep alive offloading, the TCP and IP stack implemented at the modem 313 synchronizes with the TCP and IP stack implemented at the OS 305 (e.g., as described in connection with FIGS. 5A-5B and/or FIG. 6).

By using techniques as described in connection with FIG. 3, an applications processor of the UE 120 (e.g., executing the software package 301) offloads a TCP keep alive procedure to the modem 313 of the UE 120. As a result, the applications processor conserves power and processing resources because the modem 313 periodically generates and transmits TCP keep alive packets to the remote server 303.

As indicated above, FIG. 3 is provided as an example. Other examples may differ from what is described with respect to FIG. 3.

FIGS. 4A-4D are diagrams illustrating an example 400 associated with offloading TCP keep alive packets to a modem, in accordance with the present disclosure. As shown in FIG. 4A, an application 301 (e.g., executed on an applications processor UE 120) may communicate with a remote server 303 through a driver 307 (e.g., implemented on the applications processor of the UE 120) associated with a modem 313 of the UE 120.

As shown by reference number 401, the application 301 may establish a TCP connection with the remote server 303. For example, the application 301 may send data to, and receive data from, the remote server 303 using the TCP connection.

As shown by reference number 403a, the application 301 may instruct the driver 307 to register the TCP connection with the modem 313. Accordingly, as shown by reference number 403b, the driver 307 may transmit, and the modem 313 may receive, a registration message associated with keep alive offloading. For example, the registration message may comprise a QMI_WDS_REGISTER_MODEM_ASSIST_KA_REQ message. The registration message may include an identifier associated with the TCP connection. Additionally, the registration message may include TCP tuples associated with the TCP connection.

Accordingly, as shown by reference number 405, the modem 313 may establish a filter (e.g., a hardware-based filter and/or a software-based filter) using the identifier and/or the TCP tuples. As a result, the filter identifies downlink TCP packets from the remote server 303 that are associated with the TCP connection and are forwarded to the application 301 through the modem 313, as shown by reference numbers 407a and 407b. Accordingly, as shown by reference number 409, the modem 313 may maintain (e.g., in a cache and/or another memory associated with the modem 313) a TCP state associated with the TCP connection. For example, the TCP state may include a current sequence number and a current acknowledgement number associated with the TCP connection. In some aspects, the TCP state may additionally include a payload length of a most recent incoming TCP packet.

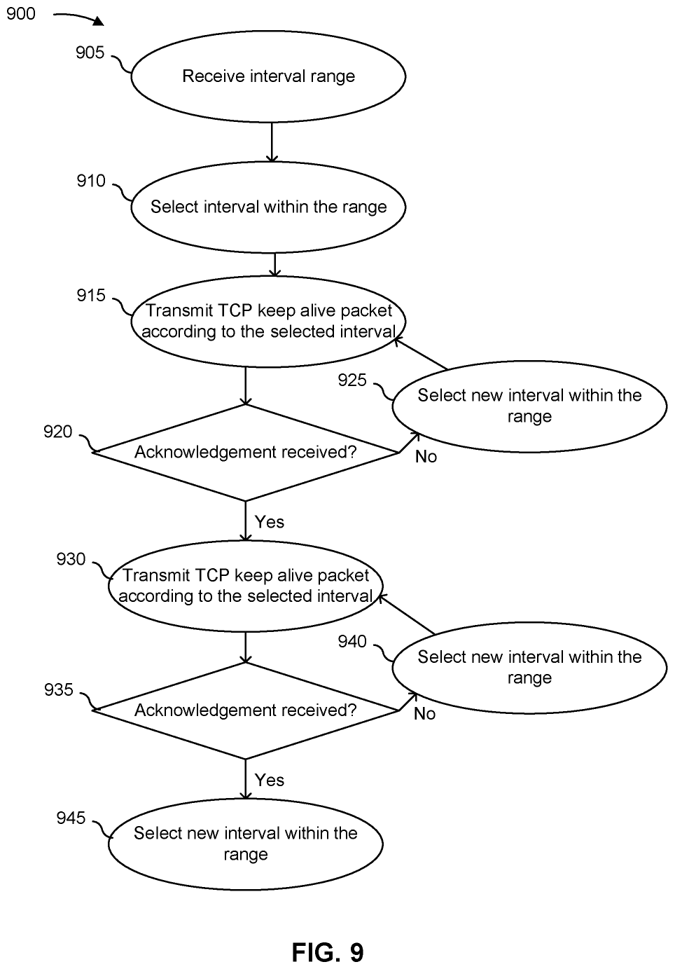

As shown in FIG. 4B, and by reference number 411a, the application 301 may instruct the driver 307 to offload a TCP keep alive procedure to the modem 313. Accordingly, as shown by reference number 411b, the driver 307 may transmit, and the modem 313 may receive, an indication to perform a keep alive procedure. For example, the indication may comprise a QMI_WDS_MODEM_ASSIST_KA_START_REQ message. In some aspects, the indication may include a value for a timer such that the modem 313 periodically transmits TCP keep alive packets according to the timer. As an alternative, the indication may include a range of values for the timer such that the modem 313 may detect a heartbeat interval for the application 301 (e.g., as described in connection with FIG. 9).

In response to the indication, and as shown by reference number 413, the modem 313 may generate a TCP keep alive packet. For example, the modem 313 may generate a TCP keep alive packet with a sequence number that is one less than the current acknowledgement number. Additionally, the modem 313 may generate the TCP keep alive packet with an empty payload. As shown by reference number 415, the modem 313 may transmit, and the remote server 303 may receive, the TCP keep alive packet.

Furthermore, as shown by reference number 417, the modem 313 may detect expiry of a timer associated with the application 301. For example, the modem 313 may start the timer each time a TCP keep alive packet is transmitted. Accordingly, in response to expiry of the timer, and as shown by reference number 419, the modem 313 may transmit, and the remote server 303 may receive, the TCP keep alive packet.

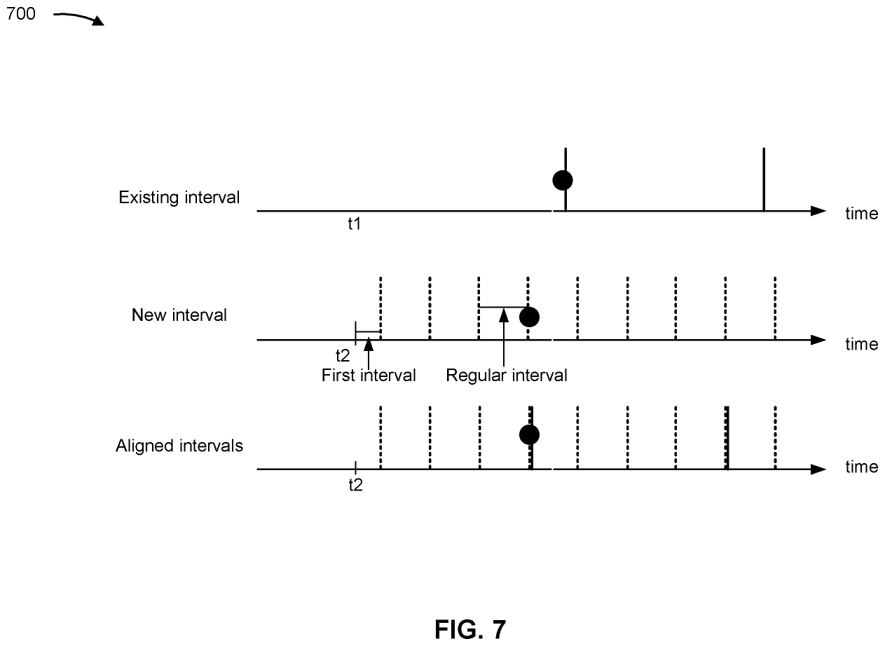

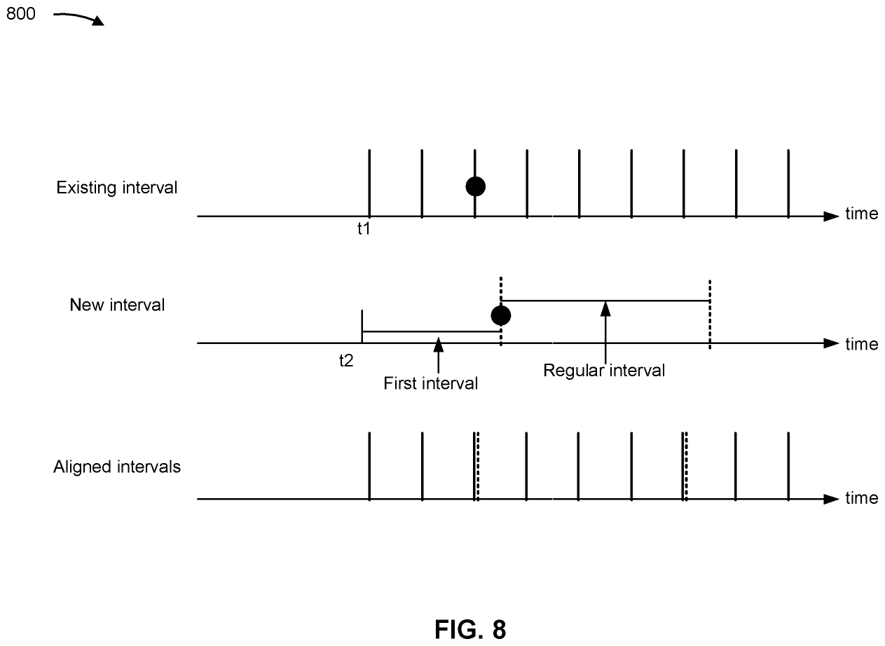

Accordingly, the modem 313 transmits, periodically, TCP keep alive packets based on the current sequence number and the current acknowledgement number. In some aspects, the modem 313 transmits the TCP keep alive packets periodically according to the timer with the value indicated by the applications processor, as described above. In some aspects, the modem 313 may determine a period for the TCP keep alive packets based at least in part on one or more preconfigured periodicities. For example, the modem 313 may only accept periodicities that are multiples of 10 seconds, such that when the applications processor indicates a value of 15 seconds, the modem 313 uses a period of 10 seconds. As a result, the modem 313 may conserve power and processing resources by only transmitting TCP keep alive packets according to the one or more preconfigured periodicities, which increases an amount of time in which the modem 313 may enter a low-power mode. Additionally, or alternatively, the modem 313 may determine a period for the TCP keep alive packets based at least in part on a discontinuous reception (DRx) cycle associated with the UE 120. For example, the modem 313 may adjust the period for the TCP keep alive packets to align with an active portion of the DRx cycle. As a result, the modem 313 may conserve power and processing resources by increasing an amount of time in which the modem 313 may remain in a sleep portion of the DRx cycle. Additionally, or alternatively, and as described in connection with FIG. 7 and FIG. 8, the modem 313 may determine a period for the TCP keep alive packets based at least in part on one or more periods associated with additional TCP keep alive packets.

In some aspects, the modem 313 may detect that the UE 120 has entered a radio resource control (RRC) connected state. Accordingly, the modem 313 may transmit one of the TCP keep alive packets early based on detecting that the UE 120 has entered the RRC connected state. By transmitting the TCP keep alive packet during the RRC connected state, the modem 313 conserves power and processing resources by not interrupting when the UE 120 is in an RRC inactive state during an originally scheduled time for the TCP keep alive packet. The modem 313 may also reset the timer associated with the application based on early transmission of the TCP keep alive packet.

As shown in FIG. 4C, and by reference number 421, the modem 313 may establish a filter (e.g., a hardware-based filter and/or a software-based filter) using the current sequence number. As a result, the filter identifies acknowledgements of the TCP keep alive packets from the remote server 303. Accordingly, as shown by reference number 423, when the modem 313 receives an acknowledgement associated with the TCP keep alive packets, the modem 313 discards the acknowledgement, as shown by reference number 425. As a result, the applications processor continues to conserve power and processing resources by not having to process the acknowledgement. Accordingly, the modem 313 may establish the filter before transmitting a first TCP keep alive packet for the application 301.

As shown by reference number 427, when the modem 313 receives a downlink packet that is not an acknowledgement associated with the TCP keep alive packets, the modem 313 forwards the downlink packet to the application 301, as shown by reference number 429.

In response to the downlink packet, and as shown in FIG. 4D by reference number 431a, the application 301 may instruct the driver 307 to stop offloading a TCP keep alive procedure to the modem 313. Accordingly, as shown by reference number 431b, the driver 307 may transmit, and the modem 313 may receive, an indication to stop performing a keep alive procedure. For example, the indication may comprise a QMI_WDS_MODEM_ASSIST_KA_STOP_REQ message. As an alternative, the application 301 may instruct the driver 307 to stop offloading a TCP keep alive procedure to the modem 313 when the application 301 has data to transmit to the remote server 303 on the TCP connection and/or when the application 301 receives an indication from the modem 313 that the modem 313 failed to receive an acknowledgement of one of the TCP keep alive packets from the remote server 303.

Accordingly, the modem 313 may refrain from transmitting the TCP keep alive packets based on the indication to stop performing the keep alive procedure. Nonetheless, as shown by reference number 433, the modem 313 may continue to filter incoming TCP packets from the remote server 303 that are associated with the TCP connection and are forwarded to the application 301 through the modem 313, as shown by reference numbers 435a and 435b. Accordingly, as shown by reference number 437, the modem 313 may maintain (e.g., in a cache and/or another memory associated with the modem 313) the TCP state associated with the TCP connection. For example, the TCP state may include a new current sequence number and a new current acknowledgement number associated with the TCP connection. In some aspects, the TCP state may additionally include a payload length of a most recent incoming TCP packet.

As a result, the application 301 may instruct the driver 307 to resume offloading a TCP keep alive procedure to the modem 313. Accordingly, the driver 307 may transmit, and the modem 313 may receive, an indication to resume a keep alive procedure. For example, the indication may comprise a QMI_WDS_MODEM_ASSIST_KA_START_REQ message. As a result, the modem 313 may transmit, and the remote server 303 may receive, periodically, new TCP keep alive packets based on the new current sequence number and the new current acknowledgement number.

In some aspects, and as shown by reference number 439a, the application 301 may instruct the driver 307 to deregister the TCP connection with the modem 313. Accordingly, as shown by reference number 439b, the driver 307 may transmit, and the modem 313 may receive, a deregistration message associated with keep alive offloading. For example, the deregistration message may comprise a QMI_WDS_DEREGISTER_MODEM_ASSIST_KA_REQ message.

In response to the deregistration message, and as shown by reference number 441, the modem 313 may remove the filter described in connection with reference number 405. Accordingly, the modem 313 no longer caches the TCP state associated with the TCP connection.

By using techniques as described in connection with FIGS. 4A-4D, the applications processor of the UE 120 (e.g., executing the application 301) offloads a TCP keep alive procedure to the modem 313 of the UE 120. As a result, the applications processor conserves power and processing resources.

As indicated above, FIGS. 4A-4D are provided as an example. Other examples may differ from what is described with respect to FIGS. 4A-4D.

FIGS. 5A-5B are diagrams illustrating an example 500 associated with offloading TCP keep alive packets to a modem, in accordance with the present disclosure. Example 500 is similar to example 400 but uses TCP keep alive packets that include non-zero payloads. Accordingly, example 500 may include operations similar to operations 401a, 401b, 403a, 403b, 405, 407a, 407b, and 409 as described in connection with FIG. 4A.

Additionally, as shown in FIG. 5A, and by reference number 501a, the application 301 may instruct the driver 307 to offload a TCP keep alive procedure to the modem 313. Accordingly, as shown by reference number 501b, the driver 307 may transmit, and the modem 313 may receive, an indication to perform a keep alive procedure. For example, the indication may comprise a QMI_WDS_MODEM_ASSIST_KA_START_REQ message. In some aspects, the indication may include a value for a timer such that the modem 313 periodically transmits TCP keep alive packets according to the timer. As an alternative, the indication may include a range of values for the timer such that the modem 313 may detect a heartbeat interval for the application 301 (e.g., as described in connection with FIG. 9). Additionally, the indication includes a payload for the TCP keep alive packets and an acknowledgement payload associated with the TCP keep alive packets (if any).

In response to the indication, and as shown by reference number 503, the modem 313 may generate a TCP keep alive packet. For example, the modem 313 may generate a TCP keep alive packet with a sequence number that starts with the current acknowledgement number and an acknowledgement number that starts with a current sequence number. Additionally, the modem 313 may generate the TCP keep alive packet with the payload included in the indication. Accordingly, as shown by reference number 505, the modem 313 may transmit, and the remote server 303 may receive, the TCP keep alive packet.

Furthermore, as shown by reference number 507, the modem 313 may update the TCP state in the cache. For example, the modem may increment the sequence number according to a length of the payload and increment the acknowledgement number according to a length of the acknowledgement payload (if any). Accordingly, when the modem 313 detects expiry of a timer associated with the application 301, as shown by reference number 509, modem 313 may generate a new TCP keep alive packet with the incremented sequence number and the incremented acknowledgement number, as shown by reference number 511. Additionally, the modem 313 may generate the new TCP keep alive packet with the payload included in the indication.

Accordingly, as shown by reference number 513, the modem 313 may transmit, and the remote server 303 may receive, the new TCP keep alive packet.

Accordingly, the modem 313 transmits, periodically, TCP keep alive packets based on the updated TCP state in the cache. The period may be determined as described in connection with FIG. 4B.

Example 500 may additionally include operations similar to operations 421, 423, 425, 427, and 429 as described in connection with FIG. 4C. The filter used in example 500 may additionally use the acknowledgement payload (if any) to filter acknowledgements.

As shown in FIG. 5B by reference number 515a, the application 301 may instruct the driver 307 to stop offloading a TCP keep alive procedure to the modem 313. Accordingly, as shown by reference number 515b, the driver 307 may transmit, and the modem 313 may receive, an indication to stop performing a keep alive procedure. For example, the indication may comprise a QMI_WDS_MODEM_ASSIST_KA_STOP_REQ message. In some aspects, the application 301 may instruct the driver 307 to stop offloading a TCP keep alive procedure to the modem 313 in response to a downlink packet from the remote server 303 forwarded to the applications processor by the modem 313. As an alternative, the application 301 may instruct the driver 307 to stop offloading a TCP keep alive procedure to the modem 313 when the application 301 has data to transmit to the remote server 303 on the TCP connection and/or when the application 301 receives an indication from the modem 313 that the modem 313 failed to receive an acknowledgement of one of the TCP keep alive packets from the remote server 303.

Accordingly, the modem 313 may refrain from transmitting the TCP keep alive packets based on the indication to stop performing the keep alive procedure. Additionally, as shown by reference number 517, the modem 313 may provide the updated TCP state to the driver 307. Accordingly, as shown by reference number 519, the driver 307 may update the TCP and IP stack according to the updated TCP state and, as shown by reference number 521, provide the updated TCP state to the application 301.

Nonetheless, as described in connection with FIG. 4D, the modem 313 may continue to filter incoming TCP packets from the remote server 303 that are associated with the TCP connection such that the application 301 may instruct the driver 307 to resume offloading a TCP keep alive procedure to the modem 313. Additionally, example 500 may include operations similar to operations 439a, 439b, and 441, as described in connection with FIG. 4D.

By using techniques as described in connection with FIGS. 5A-5B, the applications processor of the UE 120 (e.g., executing the application 301) offloads a TCP keep alive procedure to the modem 313 of the UE 120. As a result, the applications processor conserves power and processing resources.

As indicated above, FIGS. 5A-5B are provided as an example. Other examples may differ from what is described with respect to FIGS. 5A-5B.

FIG. 6 is a diagram illustrating an example 600 associated with offloading TCP keep alive packets to a modem, in accordance with the present disclosure. Example 600 is similar to example 500 but updates the TCP state at the applications processor without modifying the TCP and IP stack itself. Accordingly, example 600 may include operations similar to operations 401a, 401b, 403a, 403b, 405, 407a, 407b, and 409 as described in connection with FIG. 4A. Additionally, example 600 may include operations similar to operations 501a, 501b, 503, 505, 507, 509, 511, and 513, as described in connection with FIG. 5A. Example 600 may additionally include operations similar to operations 421, 423, 425, 427, and 429 as described in connection with FIG. 4C. The filter used in example 600 may additionally use the acknowledgement payload (if any) to filter acknowledgements.

As shown in FIG. 6, and by reference number 601a, the application 301 may instruct the driver 307 to stop offloading a TCP keep alive procedure to the modem 313. Accordingly, as shown by reference number 601b, the driver 307 may transmit, and the modem 313 may receive, an indication to stop performing a keep alive procedure. For example, the indication may comprise a QMI_WDS_MODEM_ASSIST_KA_STOP_REQ message. In some aspects, the application 301 may instruct the driver 307 to stop offloading a TCP keep alive procedure to the modem 313 in response to a downlink packet from the remote server 303 forwarded to the applications processor by the modem 313. As an alternative, the application 301 may instruct the driver 307 to stop offloading a TCP keep alive procedure to the modem 313 when the application 301 has data to transmit to the remote server 303 on the TCP connection and/or when the application 301 receives an indication from the modem 313 that the modem 313 failed to receive an acknowledgement of one of the TCP keep alive packets from the remote server 303.

Accordingly, the modem 313 may refrain from transmitting the TCP keep alive packets based on the indication to stop performing the keep alive procedure. Additionally, as shown by reference number 603a, the modem 313 may provide the updated TCP state to the driver 307, and, as shown by reference number 603b, the driver 307 may provide the updated TCP state to the application 301. Accordingly, as shown by reference number 605, the application 301 may transmit, to the remote server 303, a quantity of TCP keep alive packets corresponding to a quantity of TCP keep alive packets that were transmitted by the modem 313. Accordingly, the application 301 updates the TCP state without directly modifying the TCP and IP stack implemented at the driver 307.

Nonetheless, as described in connection with FIG. 4D, the modem 313 may continue to filter incoming TCP packets from the remote server 303 that are associated with the TCP connection such that the application 301 may instruct the driver 307 to resume offloading a TCP keep alive procedure to the modem 313. Additionally, example 600 may include operations similar to operations 439a, 439b, and 441, as described in connection with FIG. 4D.

By using techniques as described in connection with FIG. 6, the applications processor of the UE 120 (e.g., executing the application 301) offloads a TCP keep alive procedure to the modem 313 of the UE 120 without modifications to the TCP and IP stack implemented on the applications processor. As a result, the applications processor conserves power and processing resources.

As indicated above, FIG. 6 is provided as an example. Other examples may differ from what is described with respect to FIG. 6.

As described above, a UE may execute one or more applications that use TCP to communicate with one or more remote servers. Accordingly, even when no data is being sent to, or received from, a remote server, a corresponding TCP connection with an application on the UE is maintained by the application transmitting TCP keep alive packets periodically. However, different applications may be associated with different heartbeat intervals for sending TCP keep alive packets. Accordingly, an amount of time in which the UE 120 is able to be in an RRC inactive state is reduced, which causes the UE 120 to consume additional power and processing resources.

Some techniques and apparatuses described herein enable a UE (e.g., UE 120) to align heartbeat intervals associated with TCP keep alive packets. As a result, the UE 120 increases an amount of time in which the UE 120 is able to be in an RRC inactive state, which causes the UE 120 to conserve power and processing resources. Additionally, or alternatively, some techniques and apparatuses described herein enable the UE 120 to detect a range of possible heartbeat intervals associated with TCP keep alive packets. As a result, the UE 120 can select within the detected range when aligning heartbeat intervals, as described above. Additionally, or alternatively, the UE 120 can select near a longer end of the detected range in order to reduce a frequency at which the TCP keep alive packets are transmitted, which causes the UE 120 to conserve power and processing resources, without causing a corresponding TCP connection to be lost.

FIG. 7 is a diagram illustrating an example 700 associated with TCP heartbeat interval alignment, in accordance with the present disclosure. In some aspects, a UE (e.g., an applications processor of UE 120 or a modem of UE 120 to which a TCP keep alive procedure has been offloaded, as described herein) may determine a plurality of TCP heartbeat intervals based on a minimum heartbeat interval, where each TCP heartbeat interval, of the plurality of TCP heartbeat intervals, is associated with a corresponding application, of a plurality of applications, executed by the UE 120. For example, the UE 120 may determine intervalₘᵢₙ as the minimum of a set of heartbeat intervals associated with the plurality of applications. Accordingly, the UE 120 may determine an interval interval^{new}ᵢ for an application (e.g., represented by i) as

$$⌊ \frac{{interval}_{i}}{{interval}_{min}} ⌋ \times {interval}_{min} ,$$

where intervalᵢ represents a corresponding heartbeat interval originally associated with the application i. Accordingly, by setting each application's heartbeat interval to a multiple of the minimum heartbeat interval, the UE 120 aligns the heartbeat intervals to increase an amount of time in which the UE 120 is able to be in an RRC inactive state. Additionally, by using the floor function, the UE 120 reduces chances that a TCP connection will be lost by transmitting TCP keep alive packets earlier rather than later.

In some aspects, the UE 120 may additionally transmit, for each application, a first of the TCP keep alive packets according to a fraction of a corresponding TCP heartbeat interval of the plurality of TCP heartbeat intervals. For example, the fraction may be 50%, 60%, 70%, and so on. By using a shorter initial heartbeat interval, the UE 120 reduces chances that a TCP connection will be lost on account of a delay between a most recent data transmission on the TCP connection and a start of a timer for a TCP keep alive procedure on the TCP connection.

The UE 120 may re-determine the plurality of TCP heartbeat intervals after receiving an indication to stop transmitting TCP keep alive packets for one of the applications (e.g., an indication to pause or to stop from an applications processor, a TCP packet for the one of the applications that is not an acknowledgement associated with the TCP keep alive packets, or an expiry of a timer associated with receiving acknowledgement of the TCP keep alive packets for the one of the applications) and/or receiving an indication to start transmitting TCP keep alive packets for a new application (e.g., an indication to start or to resume from an applications processor).

Accordingly, as shown in FIG. 7, an existing interval may include one or more of the plurality of TCP heartbeat intervals determined as described above. In some aspects, as further shown in FIG. 7, the UE 120 may receive an indication of a new TCP heartbeat interval associated with a new application. In some aspects, the heartbeat intervals may be re-determined, as described above. Accordingly, the UE 120 may move the plurality of TCP heartbeat intervals earlier in time to align with the new TCP heartbeat interval. By moving the plurality of TCP heartbeat intervals forward, the UE 120 reduces chances that a TCP connection will be lost by transmitting TCP keep alive packets earlier rather than later.

By using techniques as described in connection with FIG. 7, the UE 120 aligns heartbeat intervals associated with TCP keep alive packets. As a result, the UE 120 increases an amount of time in which the UE 120 is able to be in an RRC inactive state, which causes the UE 120 to conserve power and processing resources.

As indicated above, FIG. 7 is provided as an example. Other examples may differ from what is described with respect to FIG. 7.

FIG. 8 is a diagram illustrating an example 800 associated with TCP heartbeat interval alignment, in accordance with the present disclosure. In some aspects, a UE (e.g., an applications processor of UE 120 or a modem of UE 120 to which a TCP keep alive procedure has been offloaded, as described herein) may determine a plurality of TCP heartbeat intervals based on a minimum heartbeat interval, where each TCP heartbeat interval, of the plurality of TCP heartbeat intervals, is associated with a corresponding application, of a plurality of applications, executed by the UE 120. For example, the UE 120 may determine the plurality of TCP heartbeat intervals as described in connection with FIG. 7.

In some aspects, the UE 120 may additionally transmit, for each application, a first of the TCP keep alive packets according to a fraction of a corresponding TCP heartbeat interval of the plurality of TCP heartbeat intervals. For example, the fraction may be 50%, 60%, 70%, and so on. By using a shorter initial heartbeat interval, the UE 120 reduces chances that a TCP connection will be lost on account of a delay between a most recent data transmission on the TCP connection and a start of a timer for a TCP keep alive procedure on the TCP connection.

The UE 120 may re-determine the plurality of TCP heartbeat intervals after receiving an indication to stop transmitting TCP keep alive packets for one of the applications (e.g., an indication to pause or to stop from an applications processor, a TCP packet for the one of the applications that is not an acknowledgement associated with the TCP keep alive packets, or an expiry of a timer associated with receiving acknowledgement of the TCP keep alive packets for the one of the applications) and/or receiving an indication to start transmitting TCP keep alive packets for a new application (e.g., an indication to start or to resume from an applications processor).

Accordingly, as shown in FIG. 8, an existing interval may include one or more of the plurality of TCP heartbeat intervals determined as described above. In some aspects, as further shown in FIG. 8, the UE 120 may receive an indication of a new TCP heartbeat interval associated with a new application. In some aspects, the heartbeat intervals may be re-determined, as described above. Accordingly, the UE 120 may move the new TCP heartbeat interval earlier in time to align with the plurality of TCP heartbeat intervals. By moving the new TCP heartbeat interval forward, the UE 120 reduces chances that a TCP connection will be lost by transmitting TCP keep alive packets earlier rather than later.

By using techniques as described in connection with FIG. 8, the UE 120 aligns heartbeat intervals associated with TCP keep alive packets. As a result, the UE 120 increases an amount of time in which the UE 120 is able to be in an RRC inactive state, which causes the UE 120 to conserve power and processing resources.

As indicated above, FIG. 8 is provided as an example. Other examples may differ from what is described with respect to FIG. 8.

FIG. 9 is a diagram illustrating an example 900 associated with TCP heartbeat interval alignment, in accordance with the present disclosure. In some aspects, a UE (e.g., an applications processor of UE 120 or a modem of UE 120 to which a TCP keep alive procedure has been offloaded, as described herein) may receive a range associated with a period (also referred to as a “heartbeat interval” or “interval”) for TCP keep alive packets (block 905). For example, the UE 120 may receive the range from a memory of the UE 120 (e.g., from a data structure associated with an application for which the TCP keep alive packets will be transmitted or as a default value).

As further shown in FIG. 9, the UE 120 may select a first interval within the range (block 910). For example, the UE 120 may randomly select the first interval. As an alternative, the UE 120 may select the first interval based on a binary search, an exponential search, a stepwise search, or a combination thereof.

Accordingly, the UE 120 may transmit the TCP keep alive packets according to the first interval within the range (block 915). The UE 120 may determine whether a TCP connection associated with the TCP keep alive packets was successfully maintained based on whether the UE 120 received one or more acknowledgements of the TCP keep alive packets (block 920). If no, the UE 120 may re-select a second interval within the range that is shorter than the first interval (block 925). For example, the UE 120 may randomly select the second interval. As an alternative, the UE 120 may select the second interval based on a binary search, an exponential search, a stepwise search, or a combination thereof. Accordingly, the UE 120 may re-establish the TCP connection and use the second interval for future TCP keep alive packets.

If yes, the UE 120 may continue to transmit the TCP keep alive packets according to the first interval within the range (block 930). The UE 120 may determine whether a TCP connection associated with the TCP keep alive packets was successfully maintained based on whether the UE 120 received one or more acknowledgements of the TCP keep alive packets (block 935). If no, the UE 120 may re-select a second interval within the range that is shorter than the first interval (block 940), as described above. Accordingly, the UE 120 may re-establish the TCP connection and use the second interval for future TCP keep alive packets. In some aspects, the UE 120 may transmit until a quantity of acknowledgements that satisfies a threshold have been received. According, the UE 120 may re-select a second interval within the range that is longer than the first interval (block 945). Accordingly, the UE 120 may re-establish the TCP connection and use the second interval for future TCP keep alive packets.

The UE 120 may repeat the process described above to determine an updated range for the TCP keep alive packets (e.g., using a third interval, a fourth interval, and so on). For example, the UE 120 may determine the updated range based on a longest successful interval (or a shortest interval associated with failure). Accordingly, the UE 120 may store the updated range (e.g., in association with the application).

By using techniques as described in connection with FIG. 9, the UE 120 detects the updated range of possible heartbeat intervals associated with TCP keep alive packets. As a result, the UE 120 can select within the detected range when aligning heartbeat intervals, as described above in connection with FIG. 7 and/or FIG. 8. Additionally, or alternatively, the UE 120 can select near a longer end of the detected range in order to reduce a frequency at which the TCP keep alive packets are transmitted, which causes the UE 120 to conserve power and processing resources, without causing a corresponding TCP connection to be lost.

As indicated above, FIG. 9 is provided as an example. Other examples may differ from what is described with respect to FIG. 9.

FIG. 10 is a diagram illustrating an example process 1000 performed, for example, by a modem, in accordance with the present disclosure. Example process 1000 is an example where the modem (e.g., included in UE 120) performs operations associated with TCP keep alive packet offloading.

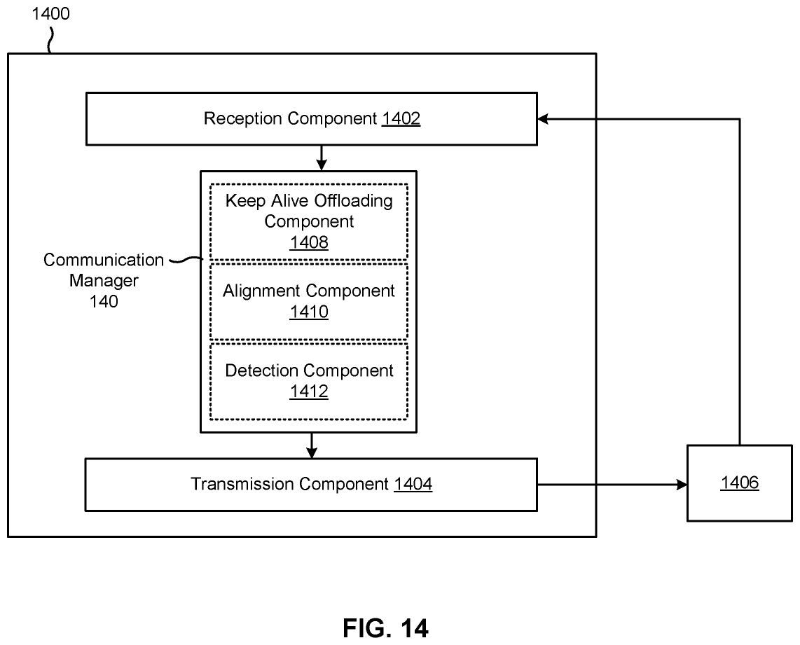

As shown in FIG. 10, in some aspects, process 1000 may include receiving, from an applications processor of the UE (e.g., communication manager 140 and/or keep alive offloading component 1408, depicted in FIG. 14), a registration message associated with keep alive offloading (block 1010). For example, the modem (e.g., included in reception component 1402 and/or transmission component 1404, depicted in FIG. 14) may receive, from an applications processor of the UE, a registration message associated with keep alive offloading, as described herein.

As further shown in FIG. 10, in some aspects, process 1000 may include filtering incoming TCP packets to determine a current sequence number and a current acknowledgement number (block 1020). For example, the modem (e.g., included in reception component 1402) may filter incoming TCP packets to determine a current sequence number and a current acknowledgement number, as described herein.

As further shown in FIG. 10, in some aspects, process 1000 may include receiving, from the applications processor, an indication to perform a keep alive procedure (block 1030). For example, the modem (e.g., included in reception component 1402 and/or transmission component 1404) may receive, from the applications processor, an indication to perform a keep alive procedure, as described herein.

As further shown in FIG. 10, in some aspects, process 1000 may include transmitting, periodically, TCP keep alive packets based on the current sequence number and the current acknowledgement number (block 1040). For example, the modem (e.g., included in transmission component 1404) may transmit, periodically, TCP keep alive packets based on the current sequence number and the current acknowledgement number, as described herein.

Process 1000 may include additional aspects, such as any single aspect or any combination of aspects described below and/or in connection with one or more other processes described elsewhere herein.

In a first aspect, the TCP keep alive packets use a sequence number that is one less than the current acknowledgement number.

In a second aspect, alone or in combination with the first aspect, the TCP keep alive packets are transmitted periodically according to a timer with a value indicated by the applications processor.

In a third aspect, alone or in combination with one or more of the first and second aspects, process 1000 further includes receiving, from the applications processor, a range associated with a period for the TCP keep alive packets; transmitting the TCP keep alive packets according to a first interval within the range; transmitting the TCP keep alive packets according to a second interval within the range based on an outcome associated with the TCP keep alive packets according to the first interval; and indicating, to the applications processor, an updated range based at least in part on the first interval and the second interval.

In a fourth aspect, alone or in combination with one or more of the first through third aspects, process 1000 further includes filtering incoming TCP packets to determine to detect acknowledgements of the TCP keep alive packets, and dropping the acknowledgements of the TCP keep alive packets.

In a fifth aspect, alone or in combination with one or more of the first through fourth aspects, process 1000 further includes filtering incoming TCP packets to determine to detect a downlink packet that is not an acknowledgement of the TCP keep alive packets, and forwarding the downlink packet to the applications processor.

In a sixth aspect, alone or in combination with one or more of the first through fifth aspects, process 1000 further includes receiving, from the applications processor, an indication to stop performing the keep alive procedure; refraining from transmitting the TCP keep alive packets based on the indication to stop performing the keep alive procedure; and continuing to filter incoming TCP packets to determine a new current sequence number and a new current acknowledgement number.

In a seventh aspect, alone or in combination with one or more of the first through sixth aspects, process 1000 further includes receiving, from the applications processor, a new indication to perform the keep alive procedure, and transmitting, periodically, new TCP keep alive packets based on the new current sequence number and the new current acknowledgement number.

In an eighth aspect, alone or in combination with one or more of the first through seventh aspects, process 1000 further includes receiving, from the applications processor, a deregistration message associated with keep alive offloading, and refraining from filtering incoming TCP packets based on the deregistration message.

In a ninth aspect, alone or in combination with one or more of the first through eighth aspects, process 1000 further includes receiving, from the applications processor, a keep alive payload, where the TCP keep alive packets include the keep alive payload.

In a tenth aspect, alone or in combination with one or more of the first through ninth aspects, the TCP keep alive packets use a sequence number that starts with the current acknowledgement number and an acknowledgement number that starts with a current sequence number and increments according to a length of an acknowledgement payload.

In an eleventh aspect, alone or in combination with one or more of the first through tenth aspects, process 1000 further includes receiving, from the applications processor, an acknowledgement payload; filtering incoming TCP packets based on the acknowledgement payload to detect acknowledgements of the TCP keep alive packets; and dropping the acknowledgements of the TCP keep alive packets.

In a twelfth aspect, alone or in combination with one or more of the first through eleventh aspects, process 1000 further includes receiving, from the applications processor, an indication to stop performing the keep alive procedure; refraining from transmitting the TCP keep alive packets based on the indication to stop performing the keep alive procedure; and transmitting a new current sequence number and a new current acknowledgement number to the applications processor.

In a thirteenth aspect, alone or in combination with one or more of the first through twelfth aspects, process 1000 further includes determining a period for the TCP keep alive packets based at least in part on one or more preconfigured periodicities.

In a fourteenth aspect, alone or in combination with one or more of the first through thirteenth aspects, process 1000 further includes determining a period for the TCP keep alive packets based at least in part on a DRx cycle associated with the UE.

In a fifteenth aspect, alone or in combination with one or more of the first through fourteenth aspects, process 1000 further includes determining a period for the TCP keep alive packets based at least in part on one or more periods associated with additional TCP keep alive packets.

In a sixteenth aspect, alone or in combination with one or more of the first through fifteenth aspects, process 1000 further includes detecting that the UE has entered an RRC connected state, and transmitting one of the TCP keep alive packets early based on detecting that the UE has entered the RRC connected state.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by an applications processor, in accordance with the present disclosure. Example process 1100 is an example where the applications processor (e.g., applications processor included in UE 120) performs operations associated with TCP keep alive packet offloading.

As shown in FIG. 11, in some aspects, process 1100 may include transmitting, to a modem of the UE (e.g., included in reception component 1402 and/or transmission component 1404, depicted in FIG. 14), a registration message associated with keep alive offloading (block 1110). For example, the applications processor (e.g., included in communication manager 140 and/or keep alive offloading component 1408, depicted in FIG. 14) may transmit, to a modem of the UE, a registration message associated with keep alive offloading, as described herein.

As further shown in FIG. 11, in some aspects, process 1100 may include transmitting, to the modem, an indication to perform a TCP keep alive procedure (block 1120). For example, the applications processor (e.g., included in communication manager 140 and/or keep alive offloading component 1408) may transmit, to the modem, an indication to perform a TCP keep alive procedure, as described herein.

As further shown in FIG. 11, in some aspects, process 1100 may include transmitting, to the modem, an indication to stop performing the keep alive procedure (block 1130). For example, the applications processor (e.g., included in communication manager 140 and/or keep alive offloading component 1408) may transmit, to the modem, an indication to stop performing the keep alive procedure, as described herein.

Process 1100 may include additional aspects, such as any single aspect or any combination of aspects described below and/or in connection with one or more other processes described elsewhere herein.

In a first aspect, process 1100 further includes transmitting, to the modem, a current sequence number and a current acknowledgement number.

In a second aspect, alone or in combination with the first aspect, process 1100 further includes transmitting, to the modem, a value for a keep alive timer.

In a third aspect, alone or in combination with one or more of the first and second aspects, process 1100 further includes transmitting, to the modem, a range associated with a period for TCP keep alive packets, and receiving, from the modem, an updated range based at least in part on a first interval and a second interval used to transmit the TCP keep alive packets.

In a fourth aspect, alone or in combination with one or more of the first through third aspects, process 1100 further includes receiving a downlink packet from the modem that is not an acknowledgement of a TCP keep alive packet.

In a fifth aspect, alone or in combination with one or more of the first through fourth aspects, process 1100 further includes transmitting, to the modem, an indication to stop performing the TCP keep alive procedure.

In a sixth aspect, alone or in combination with one or more of the first through fifth aspects, process 1100 further includes transmitting, to the modem, a new indication to perform the TCP keep alive procedure.

In a seventh aspect, alone or in combination with one or more of the first through sixth aspects, process 1100 further includes transmitting, to the modem, a deregistration message associated with keep alive offloading.

In an eighth aspect, alone or in combination with one or more of the first through seventh aspects, process 1100 further includes transmitting, to the modem, a keep alive payload.

In a ninth aspect, alone or in combination with one or more of the first through eighth aspects, process 1100 further includes transmitting, to the modem, an acknowledgement payload associated with TCP keep alive packets.

In a tenth aspect, alone or in combination with one or more of the first through ninth aspects, process 1100 further includes transmitting, to the modem, an indication to stop performing the TCP keep alive procedure, and receiving a new sequence number and a new acknowledgement number from the modem.

In an eleventh aspect, alone or in combination with one or more of the first through tenth aspects, process 1100 further includes updating a TCP stack of the applications processor to the new sequence number and the new acknowledgement number.

In a twelfth aspect, alone or in combination with one or more of the first through eleventh aspects, process 1100 further includes transmitting one or more TCP keep alive packets in order to update a TCP stack of the applications processor to the new sequence number and the new acknowledgement number.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., UE 120 and/or apparatus 1400 of FIG. 14) performs operations associated with TCP heartbeat interval alignment.

As shown in FIG. 12, in some aspects, process 1200 may include determining a plurality of TCP heartbeat intervals based on a minimum heartbeat interval, where each TCP heartbeat interval, of the plurality of TCP heartbeat intervals, is associated with a corresponding application (block 1210). For example, the UE (e.g., using communication manager 140 and/or alignment component 1410, depicted in FIG. 14) may determine a plurality of TCP heartbeat intervals based on a minimum heartbeat interval, where each TCP heartbeat interval, of the plurality of TCP heartbeat intervals, is associated with a corresponding application, as described herein.

As further shown in FIG. 12, in some aspects, process 1200 may include transmitting, for each application, TCP keep alive packets according to a corresponding interval of the plurality of TCP heartbeat intervals (block 1220). For example, the UE (e.g., using communication manager 140 and/or transmission component 1404, depicted in FIG. 14) may transmit, for each application, TCP keep alive packets according to a corresponding interval of the plurality of TCP heartbeat intervals, as described herein.

Process 1200 may include additional aspects, such as any single aspect or any combination of aspects described below and/or in connection with one or more other processes described elsewhere herein.

In a first aspect, process 1200 further includes transmitting (e.g., using communication manager 140 and/or transmission component 1404), for each application, a first of the TCP keep alive packets according to a fraction of a corresponding TCP heartbeat interval of the plurality of TCP heartbeat intervals.

In a second aspect, alone or in combination with the first aspect, process 1200 further includes receiving (e.g., using communication manager 140 and/or reception component 1402, depicted in FIG. 14) an indication of a new TCP heartbeat interval associated with a new application, and moving (e.g., using communication manager 140 and/or transmission component 1404) the plurality of TCP heartbeat intervals earlier in time to align with the new TCP heartbeat interval.

In a third aspect, alone or in combination with one or more of the first and second aspects, process 1200 further includes receiving (e.g., using communication manager 140 and/or reception component 1402) an indication of a new TCP heartbeat interval associated with a new application, and moving (e.g., using communication manager 140 and/or transmission component 1404) the new TCP heartbeat interval earlier in time to align with the plurality of TCP heartbeat intervals.

In a fourth aspect, alone or in combination with one or more of the first through third aspects, process 1200 further includes receiving (e.g., using communication manager 140 and/or reception component 1402) an indication to stop transmitting TCP keep alive packets for one of the applications, and re-determining (e.g., using communication manager 140 and/or alignment component 1410) the plurality of TCP heartbeat intervals.

In a fifth aspect, alone or in combination with one or more of the first through fourth aspects, process 1200 further includes receiving (e.g., using communication manager 140 and/or reception component 1402) an indication to start transmitting TCP keep alive packets for a new application, and re-determining (e.g., using communication manager 140 and/or alignment component 1410) the plurality of TCP heartbeat intervals.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a UE, in accordance with the present disclosure. Example process 1300 is an example where the UE (e.g., UE 120 and/or apparatus 1400 of FIG. 14) performs operations associated with TCP heartbeat interval detection.

As shown in FIG. 13, in some aspects, process 1300 may include receiving a range associated with a period for TCP keep alive packets (block 1310). For example, the UE (e.g., using communication manager 140 and/or reception component 1402, depicted in FIG. 14) may receive a range associated with a period for TCP keep alive packets, as described herein.

As further shown in FIG. 13, in some aspects, process 1300 may include transmitting the TCP keep alive packets according to a first interval within the range (block 1320). For example, the UE (e.g., using communication manager 140 and/or transmission component 1404, depicted in FIG. 14) may transmit the TCP keep alive packets according to a first interval within the range, as described herein.

As further shown in FIG. 13, in some aspects, process 1300 may include transmitting the TCP keep alive packets according to a second interval within the range based on an outcome associated with the TCP keep alive packets according to the first interval (block 1330). For example, the UE (e.g., using communication manager 140 and/or transmission component 1404) may transmit the TCP keep alive packets according to a second interval within the range based on an outcome associated with the TCP keep alive packets according to the first interval, as described herein.

As further shown in FIG. 13, in some aspects, process 1300 may include storing an updated range based at least in part on the first interval and the second interval (block 1340). For example, the UE (e.g., using communication manager 140 and/or detection component 1412, depicted in FIG. 14) may store an updated range based at least in part on the first interval and the second interval, as described herein.

Process 1300 may include additional aspects, such as any single aspect or any combination of aspects described below and/or in connection with one or more other processes described elsewhere herein.

In a first aspect, process 1300 further includes transmitting (e.g., using communication manager 140 and/or transmission component 1404) the TCP keep alive packets according to a third interval within the range based on an outcome associated with the TCP keep alive packets according to the second interval, such that the updated range is further based on the third interval.

In a second aspect, alone or in combination with the first aspect, the first interval and the second interval are selected according to a binary search, an exponential search, a stepwise search, or a combination thereof.

In a third aspect, alone or in combination with one or more of the first and second aspects, the outcome associated with first interval comprises a success or a failure.

In a fourth aspect, alone or in combination with one or more of the first through third aspects, the success is associated with receiving one or more acknowledgements of the TCP keep alive packets transmitted according to the first interval.

In a fifth aspect, alone or in combination with one or more of the first through fourth aspects, the failure is associated with not receiving an acknowledgement of at least one of the TCP keep alive packets transmitted according to the first interval.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication. The apparatus 1400 may be a UE, or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 140. The communication manager 140 may include one or more of a keep alive offloading component 1408, an alignment component 1410, or a detection component 1412, among other examples.

In some aspects, the apparatus 1400 may be configured to perform one or more operations described herein in connection with FIGS. 3, 4A-4D, 5A-5B, and/or 6-9. Additionally, or alternatively, the apparatus 1400 may be configured to perform one or more processes described herein, such as process 1000 of FIG. 10, process 1100 of FIG. 11, process 1200 of FIG. 12, process 1300 of FIG. 13, or a combination thereof. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

In some aspects, the reception component 1402 may receive (e.g., from an applications processor included in the keep alive offloading component 1408), a registration message associated with keep alive offloading. Accordingly, the reception component 1402 may filter incoming TCP packets to determine a current sequence number and a current acknowledgement number. Additionally, the reception component 1402 may receive (e.g., from the keep alive offloading component 1408) an indication to perform a keep alive procedure. Accordingly, the transmission component 1404 may transmit, periodically, TCP keep alive packets based on the current sequence number and the current acknowledgement number.

In some aspects, the keep alive offloading component 1408 may further transmit (e.g., to a modem included in the reception component 1402 and the transmission component 1404) a current sequence number and a current acknowledgement number. Additionally, or alternatively, the keep alive offloading component 1408 may further transmit a value for a keep alive timer. As an alternative, the keep alive offloading component 1408 may transmit a range associated with a period for TCP keep alive packets. Accordingly, the transmission component 1404 may transmit the TCP keep alive packets according to a first interval within the range and transmit the TCP keep alive packets according to a second interval within the range based on an outcome associated with the TCP keep alive packets according to the first interval. As a result, the keep alive offloading component 1408 may receive an updated range based at least in part on the first interval and the second interval used to transmit the TCP keep alive packets.

In some aspects, the transmission component 1404 may determine a period for the TCP keep alive packets based at least in part on one or more preconfigured periodicities. Additionally, or alternatively, the transmission component 1404 may determine a period for the TCP keep alive packets based at least in part on a DRx cycle associated with the apparatus 1400. Additionally, or alternatively, the transmission component 1404 may determine a period for the TCP keep alive packets based at least in part on one or more periods associated with additional TCP keep alive packets.

In some aspects, the transmission component 1404 may detect that the apparatus 1400 has entered an RRC connected state and may transmit one of the TCP keep alive packets early based on detecting that the apparatus 1400 has entered the RRC connected state.

In some aspects, the reception component 1402 may filter incoming TCP packets to determine to detect acknowledgements of the TCP keep alive packets and may drop the acknowledgements of the TCP keep alive packets. The reception component 1402 may filter incoming TCP packets to determine to detect a downlink packet that is not an acknowledgement of the TCP keep alive packets and forward the downlink packet to the keep alive offloading component 1408.

In some aspects, the keep alive offloading component 1408 may further transmit a keep alive payload. Accordingly, the transmission component 1404 may transmit TCP keep alive packets with the keep alive payload. Additionally, in some aspects, the keep alive offloading component 1408 may transmit an acknowledgement payload associated with TCP keep alive packets. Accordingly, the reception component 1402 may filter incoming TCP packets based on the acknowledgement payload to detect acknowledgements of the TCP keep alive packets.

In some aspects, the keep alive offloading component 1408 may transmit an indication to stop performing the TCP keep alive procedure. Accordingly, the transmission component 1404 may refrain from transmitting the TCP keep alive packets based on the indication to stop performing the keep alive procedure. However, the reception component 1402 may continue to filter incoming TCP packets to determine a new current sequence number and a new current acknowledgement number. As a result, the keep alive offloading component 1408 may transmit a new indication to perform the keep alive procedure. Accordingly, the transmission component 1404 may transmit, periodically, new TCP keep alive packets based on the new current sequence number and the new current acknowledgement number.

In some aspects, the keep alive offloading component 1408 may receive a new sequence number and a new acknowledgement number based on the indication to stop perform the TCP keep alive procedure. Accordingly, the keep alive offloading component 1408 may update a TCP stack of the applications processor to the new sequence number and the new acknowledgement number or may transmit one or more TCP keep alive packets in order to update a TCP stack of the applications processor to the new sequence number and the new acknowledgement number.

In some aspects, the keep alive offloading component 1408 may transmit a deregistration message associated with keep alive offloading. As a result, the reception component 1402 may refrain from filtering incoming TCP packets based on the deregistration message.

In some aspects, the alignment component 1410 may determine a plurality of TCP heartbeat intervals based on a minimum heartbeat interval, where each TCP heartbeat interval, of the plurality of TCP heartbeat intervals, is associated with a corresponding application. The alignment component 1410 may include a modem and/or an applications processor of the UE. Accordingly, the transmission component 1404 may transmit, for each application, TCP keep alive packets according to a corresponding interval of the plurality of TCP heartbeat intervals.

In some aspects, the transmission component 1404 may transmit, for each application, a first of the TCP keep alive packets according to a fraction of a corresponding TCP heartbeat interval of the plurality of TCP heartbeat intervals.

In some aspects, the reception component 1402 may receive an indication of a new TCP heartbeat interval associated with a new application. Accordingly, the alignment component 1410 may move the plurality of TCP heartbeat intervals earlier in time to align with the new TCP heartbeat interval. As an alternative, the alignment component 1410 may move the new TCP heartbeat interval earlier in time to align with the plurality of TCP heartbeat intervals.

In some aspects, the reception component 1402 may receive an indication to stop transmitting TCP keep alive packets for one of the applications. Accordingly, the alignment component 1410 may re-determine the plurality of TCP heartbeat intervals.

In some aspects, the reception component 1402 may receive an indication to start transmitting TCP keep alive packets for a new application. Accordingly, the alignment component 1410 may re-determine the plurality of TCP heartbeat intervals.

In some aspects, the reception component 1402 may receive a range associated with a period for TCP keep alive packets. Accordingly, the transmission component 1404 may transmit the TCP keep alive packets according to a first interval within the range and may transmit the TCP keep alive packets according to a second interval within the range based on an outcome associated with the TCP keep alive packets according to the first interval. As a result, the detection component 1412 may store an updated range based at least in part on the first interval and the second interval. The detection component 1412 may include a modem and/or an applications processor of the UE.

In some aspects, the transmission component 1404 may transmit the TCP keep alive packets according to a third interval within the range based on an outcome associated with the TCP keep alive packets according to the second interval, such that the detection component 1412 determines the updated range further based on the third interval.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:
Aspect 1: A method of wireless communication performed by a modem of a user equipment (UE), comprising: receiving, from an applications processor of the UE, a registration message associated with keep alive offloading; filtering incoming transmission control protocol (TCP) packets to determine a current sequence number and a current acknowledgement number; receiving, from the applications processor, an indication to perform a keep alive procedure; and transmitting, periodically, TCP keep alive packets based on the current sequence number and the current acknowledgement number.
Aspect 2: The method of Aspect 1, wherein the TCP keep alive packets are transmitted periodically according to a timer with a value indicated by the applications processor.
Aspect 3: The method of Aspect 1, further comprising: receiving, from the applications processor, a range associated with a period for the TCP keep alive packets; transmitting the TCP keep alive packets according to a first interval within the range; transmitting the TCP keep alive packets according to a second interval within the range based on an outcome associated with the TCP keep alive packets according to the first interval; and indicating, to the applications processor, an updated range based at least in part on the first interval and the second interval.
Aspect 4: The method of any of Aspects 1 through 3, further comprising: filtering incoming TCP packets to determine to detect acknowledgements of the TCP keep alive packets; and dropping the acknowledgements of the TCP keep alive packets.
Aspect 5: The method of any of Aspects 1 through 4, further comprising: filtering incoming TCP packets to determine to detect a downlink packet that is not an acknowledgement of the TCP keep alive packets; and forwarding the downlink packet to the applications processor.
Aspect 6: The method of any of Aspects 1 through 5, further comprising: receiving, from the applications processor, an indication to stop performing the keep alive procedure; refraining from transmitting the TCP keep alive packets based on the indication to stop performing the keep alive procedure; and continuing to filter incoming TCP packets to determine a new current sequence number and a new current acknowledgement number.
Aspect 7: The method of Aspect 6, further comprising: receiving, from the applications processor, a new indication to perform the keep alive procedure; and transmitting, periodically, new TCP keep alive packets based on the new current sequence number and the new current acknowledgement number.
Aspect 8: The method of any of Aspects 1 through 7, further comprising: receiving, from the applications processor, a deregistration message associated with keep alive offloading; and refraining from filtering incoming TCP packets based on the deregistration message.
Aspect 9: The method of any of Aspects 1 through 8, wherein the TCP keep alive packets use a sequence number that is one less than the current acknowledgement number.
Aspect 10: The method of any of Aspects 1 through 9, further comprising: receiving, from the applications processor, a keep alive payload, wherein the TCP keep alive packets include the keep alive payload.
Aspect 11: The method of Aspect 10, wherein the TCP keep alive packets use a sequence number that starts with the current acknowledgement number and an acknowledgement number that starts with the current sequence number and increments according to a length of an acknowledgement payload.
Aspect 12: The method of any of Aspects 10 through 11, further comprising: receiving, from the applications processor, an acknowledgement payload; filtering incoming TCP packets based on the acknowledgement payload to detect acknowledgements of the TCP keep alive packets; and dropping the acknowledgements of the TCP keep alive packets.
Aspect 13: The method of any of Aspects 10 through 12, further comprising: receiving, from the applications processor, an indication to stop performing the keep alive procedure; refraining from transmitting the TCP keep alive packets based on the indication to stop performing the keep alive procedure; and transmitting a new current sequence number and a new current acknowledgement number to the applications processor.
Aspect 14: The method of any of Aspects 1 through 13, further comprising: determining a period for the TCP keep alive packets based at least in part on one or more preconfigured periodicities.
Aspect 15: The method of any of Aspects 1 through 14, further comprising: determining a period for the TCP keep alive packets based at least in part on a discontinuous reception (DRx) cycle associated with the UE.
Aspect 16: The method of any of Aspects 1 through 15, further comprising: determining a period for the TCP keep alive packets based at least in part on one or more periods associated with additional TCP keep alive packets.
Aspect 17: The method of any of Aspects 1 through 16, further comprising: detecting that the UE has entered a radio resource control (RRC) connected state; and transmitting one of the TCP keep alive packets early based on detecting that the UE has entered the RRC connected state.
Aspect 18: A method of wireless communication performed by an applications processor of a user equipment (UE), comprising: transmitting, to a modem of the UE, a registration message associated with keep alive offloading; transmitting, to the modem, an indication to perform a transmission control protocol (TCP) keep alive procedure; and transmitting, to the modem, an indication to stop performing the keep alive procedure.
Aspect 19: The method of Aspect 18, further comprising: transmitting, to the modem, a current sequence number and a current acknowledgement number.
Aspect 20: The method of any of Aspects 18 through 19, further comprising: transmitting, to the modem, a value for a keep alive timer.
Aspect 21: The method of any of Aspects 18 through 19, further comprising: transmitting, to the modem, a range associated with a period for TCP keep alive packets; and receiving, from the modem, an updated range based at least in part on a first interval and a second interval used to transmit the TCP keep alive packets.
Aspect 22: The method of any of Aspects 18 through 21, further comprising: receiving a downlink packet from the modem that is not an acknowledgement of a TCP keep alive packet.
Aspect 23: The method of any of Aspects 18 through 22, further comprising: transmitting, to the modem, an indication to stop performing the TCP keep alive procedure.
Aspect 24: The method of Aspect 23, further comprising: transmitting, to the modem, a new indication to perform the TCP keep alive procedure.
Aspect 25: The method of any of Aspects 18 through 24, further comprising: transmitting, to the modem, a deregistration message associated with keep alive offloading.
Aspect 26: The method of any of Aspects 18 through 25, further comprising: transmitting, to the modem, a keep alive payload.
Aspect 27: The method of Aspect 26, further comprising: transmitting, to the modem, an acknowledgement payload associated with TCP keep alive packets.
Aspect 28: The method of any of Aspects 26 through 27, further comprising: transmitting, to the modem, an indication to stop performing the TCP keep alive procedure; and receiving a new sequence number and a new acknowledgement number from the modem.
Aspect 29: The method of Aspect 28, further comprising: updating a TCP stack of the applications processor to the new sequence number and the new acknowledgement number.
Aspect 30: The method of Aspect 28, further comprising: transmitting one or more TCP keep alive packets in order to update a TCP stack of the applications processor to the new sequence number and the new acknowledgement number.
Aspect 31: A method of wireless communication performed by a user equipment (UE), comprising: determining a plurality of transmission control protocol (TCP) heartbeat intervals based on a minimum heartbeat interval, wherein each TCP heartbeat interval, of the plurality of TCP heartbeat intervals, is associated with a corresponding application; and transmitting, for each application, TCP keep alive packets according to a corresponding interval of the plurality of TCP heartbeat intervals.
Aspect 32: The method of Aspect 31, further comprising: transmitting, for each application, a first of the TCP keep alive packets according to a fraction of a corresponding TCP heartbeat interval of the plurality of TCP heartbeat intervals.
Aspect 33: The method of any of Aspects 31 through 32, further comprising: receiving an indication of a new TCP heartbeat interval associated with a new application; and moving the plurality of TCP heartbeat intervals earlier in time to align with the new TCP heartbeat interval.
Aspect 34: The method of any of Aspects 31 through 33, further comprising: receiving an indication of a new TCP heartbeat interval associated with a new application; and moving the new TCP heartbeat interval earlier in time to align with the plurality of TCP heartbeat intervals.
Aspect 35: The method of any of Aspects 31 through 34, further comprising: receiving an indication to stop transmitting TCP keep alive packets for one of the applications; and re-determining the plurality of TCP heartbeat intervals.
Aspect 36: The method of any of Aspects 31 through 35, further comprising: receiving an indication to start transmitting TCP keep alive packets for a new application; and re-determining the plurality of TCP heartbeat intervals.
Aspect 37: A method of wireless communication performed by a user equipment (UE), comprising: receiving a range associated with a period for transmission control protocol (TCP) keep alive packets; transmitting the TCP keep alive packets according to a first interval within the range; transmitting the TCP keep alive packets according to a second interval within the range based on an outcome associated with the TCP keep alive packets according to the first interval; and storing an updated range based at least in part on the first interval and the second interval.
Aspect 38: The method of Aspect 37, further comprising: transmitting the TCP keep alive packets according to a third interval within the range based on an outcome associated with the TCP keep alive packets according to the second interval, wherein the updated range is further based on the third interval.
Aspect 39: The method of any of Aspects 37 through 38, wherein the first interval and the second interval are selected according to a binary search, an exponential search, a stepwise search, or a combination thereof.
Aspect 40: The method of any of Aspects 37 through 39, wherein the outcome associated with first interval comprises a success or a failure.
Aspect 41: The method of Aspect 40, wherein the success is associated with receiving one or more acknowledgements of the TCP keep alive packets transmitted according to the first interval.
Aspect 42: The method of any of Aspects 40 through 41, wherein the failure is associated with not receiving an acknowledgement of at least one of the TCP keep alive packets transmitted according to the first interval.
Aspect 43: An apparatus for wireless communication at a device, comprising a processor; memory coupled with the processor; and instructions stored in the memory and executable by the processor to cause the apparatus to perform the method of one or more of Aspects 1-17.
Aspect 44: A device for wireless communication, comprising a memory and one or more processors coupled to the memory, the one or more processors configured to perform the method of one or more of Aspects 1-17.
Aspect 45: An apparatus for wireless communication, comprising at least one means for performing the method of one or more of Aspects 1-17.
Aspect 46: A non-transitory computer-readable medium storing code for wireless communication, the code comprising instructions executable by a processor to perform the method of one or more of Aspects 1-17.
Aspect 47: A non-transitory computer-readable medium storing a set of instructions for wireless communication, the set of instructions comprising one or more instructions that, when executed by one or more processors of a device, cause the device to perform the method of one or more of Aspects 1-17.
Aspect 48: An apparatus for wireless communication at a device, comprising a processor; memory coupled with the processor; and instructions stored in the memory and executable by the processor to cause the apparatus to perform the method of one or more of Aspects 18-30.
Aspect 49: A device for wireless communication, comprising a memory and one or more processors coupled to the memory, the one or more processors configured to perform the method of one or more of Aspects 18-30.
Aspect 50: An apparatus for wireless communication, comprising at least one means for performing the method of one or more of Aspects 18-30.
Aspect 51: A non-transitory computer-readable medium storing code for wireless communication, the code comprising instructions executable by a processor to perform the method of one or more of Aspects 18-30.
Aspect 52: A non-transitory computer-readable medium storing a set of instructions for wireless communication, the set of instructions comprising one or more instructions that, when executed by one or more processors of a device, cause the device to perform the method of one or more of Aspects 18-30.
Aspect 53: An apparatus for wireless communication at a device, comprising a processor; memory coupled with the processor; and instructions stored in the memory and executable by the processor to cause the apparatus to perform the method of one or more of Aspects 31-36.
Aspect 54: A device for wireless communication, comprising a memory and one or more processors coupled to the memory, the one or more processors configured to perform the method of one or more of Aspects 31-36.
Aspect 55: An apparatus for wireless communication, comprising at least one means for performing the method of one or more of Aspects 31-36.
Aspect 56: A non-transitory computer-readable medium storing code for wireless communication, the code comprising instructions executable by a processor to perform the method of one or more of Aspects 31-36.
Aspect 57: A non-transitory computer-readable medium storing a set of instructions for wireless communication, the set of instructions comprising one or more instructions that, when executed by one or more processors of a device, cause the device to perform the method of one or more of Aspects 31-36.
Aspect 58: An apparatus for wireless communication at a device, comprising a processor; memory coupled with the processor; and instructions stored in the memory and executable by the processor to cause the apparatus to perform the method of one or more of Aspects 37-42.
Aspect 59: A device for wireless communication, comprising a memory and one or more processors coupled to the memory, the one or more processors configured to perform the method of one or more of Aspects 37-42.
Aspect 60: An apparatus for wireless communication, comprising at least one means for performing the method of one or more of Aspects 37-42.
Aspect 61: A non-transitory computer-readable medium storing code for wireless communication, the code comprising instructions executable by a processor to perform the method of one or more of Aspects 37-42.
Aspect 62: A non-transitory computer-readable medium storing a set of instructions for wireless communication, the set of instructions comprising one or more instructions that, when executed by one or more processors of a device, cause the device to perform the method of one or more of Aspects 37-42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a modem of a user equipment (UE), comprising:
a memory; and
one or more processors, coupled to the memory, configured to:
receive, from an applications processor of the UE, a registration message associated with keep alive offloading;
filter incoming transmission control protocol (TCP) packets to determine a current sequence number and a current acknowledgement number;
receive, from the applications processor, an indication to perform a keep alive procedure; and
transmit, periodically, TCP keep alive packets based on the current sequence number and the current acknowledgement number.

2. The apparatus of claim 1, wherein the one or more processors are further configured to:
receive, from the applications processor, a range associated with a period for the TCP keep alive packets;
transmit the TCP keep alive packets according to a first interval within the range;
transmit the TCP keep alive packets according to a second interval within the range based on an outcome associated with the TCP keep alive packets according to the first interval; and
indicate, to the applications processor, an updated range based at least in part on the first interval and the second interval.

3. The apparatus of claim 1, wherein the one or more processors are further configured to:
filter incoming TCP packets to determine to detect acknowledgements of the TCP keep alive packets; and
drop the acknowledgements of the TCP keep alive packets.

4. The apparatus of claim 1, wherein the one or more processors are further configured to:
filter incoming TCP packets to determine to detect a downlink packet that is not an acknowledgement of the TCP keep alive packets; and
forward the downlink packet to the applications processor.

5. The apparatus of claim 4, wherein the one or more processors are further configured to:
receive, from the applications processor, an indication to stop performing the keep alive procedure;
refrain from transmitting the TCP keep alive packets based on the indication to stop performing the keep alive procedure; and
continue to filter incoming TCP packets to determine a new current sequence number and a new current acknowledgement number.

6. The apparatus of claim 5, wherein the one or more processors are further configured to:
receive, from the applications processor, a new indication to perform the keep alive procedure; and
transmit, periodically, new TCP keep alive packets based on the new current sequence number and the new current acknowledgement number.

7. The apparatus of claim 1, wherein the one or more processors are further configured to:
receive, from the applications processor, a deregistration message associated with keep alive offloading; and
refrain from filtering incoming TCP packets based on the deregistration message.

8. The apparatus of claim 1, wherein the one or more processors are further configured to:
receive, from the applications processor, a keep alive payload,
wherein the TCP keep alive packets include the keep alive payload.

9. The apparatus of claim 8, wherein the one or more processors are further configured to:
receive, from the applications processor, an acknowledgement payload;
filter incoming TCP packets based on the acknowledgement payload to detect acknowledgements of the TCP keep alive packets; and
drop the acknowledgements of the TCP keep alive packets.

10. The apparatus of claim 8, wherein the one or more processors are further configured to:
receive, from the applications processor, an indication to stop performing the keep alive procedure;
refrain from transmitting the TCP keep alive packets based on the indication to stop performing the keep alive procedure; and
transmit a new current sequence number and a new current acknowledgement number to the applications processor.

11. The apparatus of claim 1, wherein the one or more processors are further configured to:
determine a period for the TCP keep alive packets based at least in part on one or more preconfigured periodicities.

12. The apparatus of claim 1, wherein the one or more processors are further configured to:
determine a period for the TCP keep alive packets based at least in part on a discontinuous reception (DRx) cycle associated with the UE.

13. The apparatus of claim 1, wherein the one or more processors are further configured to:
determine a period for the TCP keep alive packets based at least in part on one or more periods associated with additional TCP keep alive packets.

14. The apparatus of claim 1, wherein the one or more processors are further configured to:
detect that the UE has entered a radio resource control (RRC) connected state; and
transmit one of the TCP keep alive packets early based on detecting that the UE has entered the RRC connected state.

15. An apparatus for wireless communication at an applications processor of a user equipment (UE), comprising:
a memory; and
one or more processors, coupled to the memory, configured to:
transmit, to a modem of the UE, a registration message associated with keep alive offloading;
transmit, to the modem, an indication to perform a transmission control protocol (TCP) keep alive procedure; and
transmit, to the modem, an indication to stop performing the keep alive procedure.

16. The apparatus of claim 15, wherein the one or more processors are further configured to:
transmit, to the modem, a current sequence number and a current acknowledgement number.

17. The apparatus of claim 15, wherein the one or more processors are further configured to:
transmit, to the modem, a value for a keep alive timer.

18. The apparatus of claim 15, wherein the one or more processors are further configured to:
transmit, to the modem, a range associated with a period for TCP keep alive packets; and
receive, from the modem, an updated range based at least in part on a first interval and a second interval used to transmit the TCP keep alive packets.

19. The apparatus of claim 15, wherein the one or more processors are further configured to:
receive a downlink packet from the modem that is not an acknowledgement of a TCP keep alive packet.

20. The apparatus of claim 19, wherein the one or more processors are further configured to:
transmit, to the modem, an indication to stop performing the TCP keep alive procedure.

21. The apparatus of claim 20, wherein the one or more processors are further configured to:
transmit, to the modem, a new indication to perform the TCP keep alive procedure.

22. The apparatus of claim 15, wherein the one or more processors are further configured to:
transmit, to the modem, a deregistration message associated with keep alive offloading.

23. The apparatus of claim 15, wherein the one or more processors are further configured to:
transmit, to the modem, a keep alive payload.

24. The apparatus of claim 23, wherein the one or more processors are further configured to:
transmit, to the modem, an acknowledgement payload associated with TCP keep alive packets.

25. The apparatus of claim 23, wherein the one or more processors are further configured to:
transmit, to the modem, an indication to stop performing the TCP keep alive procedure; and
receive a new sequence number and a new acknowledgement number from the modem.

26. The apparatus of claim 25, wherein the one or more processors are further configured to:
update a TCP stack of the applications processor to the new sequence number and the new acknowledgement number.

27. The apparatus of claim 25, wherein the one or more processors are further configured to:
transmit one or more TCP keep alive packets in order to update a TCP stack of the applications processor to the new sequence number and the new acknowledgement number.

28. An apparatus for wireless communication at a user equipment (UE), comprising:
a memory; and
one or more processors, coupled to the memory, configured to:
determine a plurality of transmission control protocol (TCP) heartbeat intervals based on a minimum heartbeat interval, wherein each TCP heartbeat interval, of the plurality of TCP heartbeat intervals, is associated with a corresponding application; and
transmit, for each application, TCP keep alive packets according to a corresponding interval of the plurality of TCP heartbeat intervals,
re-determine the plurality of TCP heartbeat intervals.

29. An apparatus for wireless communication at a user equipment (UE), comprising:
a memory; and
one or more processors, coupled to the memory, configured to:
receive a range associated with a period for transmission control protocol (TCP) keep alive packets;
transmit the TCP keep alive packets according to a first interval within the range;
transmit the TCP keep alive packets according to a second interval within the range based on an outcome associated with the TCP keep alive packets according to the first interval; and
store an updated range based at least in part on the first interval and the second interval.

30. The apparatus of claim 29, wherein the one or more processors are further configured to:
transmit the TCP keep alive packets according to a third interval within the range based on an outcome associated with the TCP keep alive packets according to the second interval,
wherein the updated range is further based on the third interval.
